(19) United States
(12) Patent Application Publication
(10) Pub. No.: US 2025/0298499 A1
(43) Pub. Date: Sep. 25, 2025

(54) SHARABLE RECORDS FOR PERFORMING ACTIONS USING A WEB BROWSING APPLICATION

(71) Applicant: Citrix Systems, Inc., Fort Lauderdale, FL (US)

(72) Inventors: Peng Yao, Nanjing (CN); Tianyu Xiao, Nanjing (CN)

(21) Appl. No.: 18/869,550

(22) PCT Filed: Sep. 23, 2022
(86) PCT No.: PCT/CN2022/120776

§ 371 Date: Dec. 3, 2024

(51) Int. Cl. G06F 3/04842; G06F 3/0481; G06F 9/451; G06F 16/955

(52) U.S. Cl. CPC G06F 3/04842; G06F 3/0481; G06F 9/451; G06F 16/9566

(57) ABSTRACT

One disclosed method involves (A) displaying a first web page retrieved using a first URL, the first web page including at least a first UI element, (B) in response to a user providing a first input corresponding to the first UI element, storing first data representing the first URL and second data identifying the first UI element, (C) in response to the user providing a second input corresponding to the first UI element, retrieving a second web page using a second URL associated with the first UI element, the second web page including at least a second UI element, and (D) generating a sharable record including at least the first data and the second data, the sharable record being configured to be accessed by a browser to identify the first UI element on the first web page.

### BACKGROUND

This application claims the benefit of and is a National Stage Application under 35 U.S.C. § 371 of International Patent Cooperation Treaty (PCT) Application No. PCT/CN2022/120776 (filed Sep. 30, 2022). All applications and references listed in this paragraph are incorporated here by reference in their entirety.

### BACKGROUND

Various systems have been developed that allow client devices to access applications and/or data files over a network. Certain products offered by Citrix Systems, Inc., of Fort Lauderdale, FL, including the Citrix Workspace™ family of products, provide such capabilities.

### SUMMARY

This Summary is provided to introduce a selection of concepts in a simplified form that are further described below in the Detailed Description. This Summary is not intended to identify key features or essential features, nor is it intended to limit the scope of the claims included herewith.

In some of the disclosed embodiments, a method comprises displaying, by a computing device, a first web page retrieved using a first uniform resource locator (URL), the first web page including at least a first user interface (UI) element; in response to a user providing a first input corresponding to the first UI element, storing first data representing the first URL and second data identifying the first UI element, the second data being stored in association with the first data; in response to the user providing a second input corresponding to the first UI element, retrieving a second web page using a second URL associated with the first UI element, the second web page including at least a second UI element; and generating a sharable record including at least the first data and the second data, the sharable record being configured to be accessed by a browser to identify, based on the second data being associated with the first data, the first UI element on the first web page when the first web page is rendered by the browser.

In some embodiments, a computing system comprises at least one processor, and at least one computer-readable medium encoded with instructions which, when executed by the at least one processor, cause the computing system to display, by a computing device, at least a first UI element corresponding to a sharable record, the sharable record including first data representing a first URL corresponding to a first web page and second data identifying a second UI element on the first web page; in response to a user providing a first input selecting the first UI element, display, using the first URL, the first web page, the first web page including the second UI element and at least a third UI element; cause, based at least in part on the second data, the third UI element to be un-selectable; and in response to detecting selection of the second UI element, take at least one first action.

In some embodiments, at least one non-transitory computer-readable medium is encoded with instructions which, when executed by at least one processor of a computing system, cause the computing system to display, by a computing device, at least a first UI element corresponding to a sharable record, the sharable record including first data representing a first URL corresponding to a first web page and second data identifying a second UI element on the first web page; in response to a user providing a first input selecting the first UI element, display, using the first URL, the first web page, the first web page including the second UI element and at least a third UI element; cause, based at least in part on the second data, the third UI element to be un-selectable; and in response to detecting selection of the second UI element, take at least one first action.

### BRIEF DESCRIPTION OF THE DRAWINGS

Objects, aspects, features, and advantages of embodiments disclosed herein will become more fully apparent from the following detailed description, the appended claims, and the accompanying figures in which like reference numerals identify similar or identical elements. Reference numerals that are introduced in the specification in association with a figure may be repeated in one or more subsequent figures without additional description in the specification in order to provide context for other features, and not every element may be labeled in every figure. The drawings are not necessarily to scale, emphasis instead being placed upon illustrating embodiments, principles and concepts. The drawings are not intended to limit the scope of the claims included herewith.

FIG. 1A shows a first example system configured to generate sharable records for performing actions using a web browsing application in accordance with some aspects of the present disclosure;

FIG. 1B shows a first example display screen of the first client device shown in FIG. 1A;

FIG. 1C shows a second example display screen of the first client device shown in FIG. 1A;

FIG. 1D shows a third example display screen of the first client device shown in FIG. 1A;

FIG. 1E shows a fourth example display screen of the first client device shown in FIG. 1A;

FIG. 2A shows a second example system configured to process sharable records for performing actions using a web browsing application in accordance with some aspects of the present disclosure;

FIG. 2B shows a first example display screen of the second client device shown in FIG. 2A;

FIG. 2C shows a second example display screen of the second client device shown in FIG. 2A;

FIG. 2D shows a third example display screen of the second client device shown in FIG. 2A.

FIG. 3 is a diagram of a network environment in which some embodiments of the system disclosed herein may be deployed;

FIG. 4 is a block diagram of a computing system that may be used to implement one or more of the components of the computing environment shown in FIG. 3 in accordance with some embodiments;

FIG. 5 is a schematic block diagram of a cloud computing environment in which various aspects of the disclosure may be implemented;

FIG. 6A is a block diagram of an example system in which resource management services may manage and streamline access by clients to resource feeds (via one or more gateway service) and/or software-as-a-service (SaaS) applications;

FIG. 6B is a block diagram showing an example implementation of the system shown in FIG. 6A in which various resource management services as well as a gateway service are located within a cloud computing environment;

FIG. 6C is a block diagram similar to that shown in FIG. 6B, but in which the available resources are represented by a single box labeled “systems of record,” and further in which several different service are included among the resource management services;

FIG. 6D shows how a display screen may appear when an intelligent activity feed feature of a multi-resource management system, such as that shown in FIG. 6C, is employed;

FIG. 7 shows an example sharable record table in accordance with some aspects of the present disclosure;

FIG. 8 shows an example implementation of certain components of the system shown in FIGS. 1A and 2A;

FIG. 9 shows an example routine that may be executed by the operation flow record generation engine shown in FIGS. 1A and 8 to enable the generation of sharable records for performing actions using a web browser in accordance with some embodiments; and

FIG. 10 shows an example routine that may be executed by the operation flow record processing engine shown in FIGS. 2A and 8 to enable the processing of sharable records for performing actions using a web browser in accordance with some embodiments.

### DETAILED DESCRIPTION

For purposes of reading the description of the various embodiments below, the following descriptions of the sections of the specification and their respective contents may be helpful:

Section A provides an introduction to illustrative example embodiments of a system configured to generate and/or process sharable records for performing actions using a web browsing application in accordance with some aspects of the present disclosure;

Section B describes a network environment which may be useful for practicing embodiments described herein;

Section C describes a computing system which may be useful for practicing embodiments described herein;

Section D describes embodiments of systems and methods for delivering shared resources using a cloud computing environment;

Section E describes embodiments of systems and methods for managing and streamlining access by client devices to a variety of resources;

Section F provides a more detailed description of example embodiments of the system introduced in Section A; and

Section G describes example implementations of methods, systems/devices, and computer-readable media in accordance with the present disclosure.

### A. Introduction to Illustrative Embodiments of a System Configured to Generate and/or Process Sharable Records for Performing Actions Using a Web Browsing Application

Users often utilize web browsing applications (web browsers) to navigate the World Wide Web and access various websites and applications, including Software-as-a-Service (SaaS) applications. Each of these websites/applications may provide functionality associated with varying levels of complexity and may thus require varying levels of knowledge in order to be properly utilized. As such, a user may require some amount of training or guidance when navigating different aspects of these websites/applications. Traditionally, a user may receive training by viewing a training video, reading training instructions, using an image-based guide, etc. Each of these traditional methods of training require the user to properly interpret the training instructions and perform the corresponding actions on/in the website/application. This may result in inaccurate use of certain functionality of the websites/applications. Further, these traditional methods may give rise to security concerns, e.g., because they may require the sending of documents including potentially sensitive (e.g., privileged, confidential, financial, and/or personal) information concerning operations of particular websites/applications (e.g., images of/instructions for a company's HR website/application).

Offered are systems and techniques for generating and/or processing sharable records for performing actions using a web browsing application. In some implementations, a system may determine that a user intends to identify steps to be added to a sharable record, record subsequent actions performed by the user with respect to one or more user interface (UI) elements, and send a sharable record representing the actions to one or more recipients. Further, in some implementations, the system may additionally or alternatively determine that a recipient user has provided an input selecting a sharable record, determine actions represented in the sharable record, and guide the user to perform such actions. In some implementations, for one or more individual actions represented in the sharable record, the system may identify a particular UI element that is to be selected on a web page and also cause all of the other UI elements on that same web page to be un-selectable, thus ensuring that the user selects the correct UI element to perform that action.

A “sharable record” of the type disclosed herein may be configured in any of numerous ways and may take on any of numerous forms. In various implementations, for example, such a sharable record may be any type of document, file, data structure, message, code module, etc., that is configured to guide a user to select one or more particular UI elements on one or more particular web pages in the manner described herein.

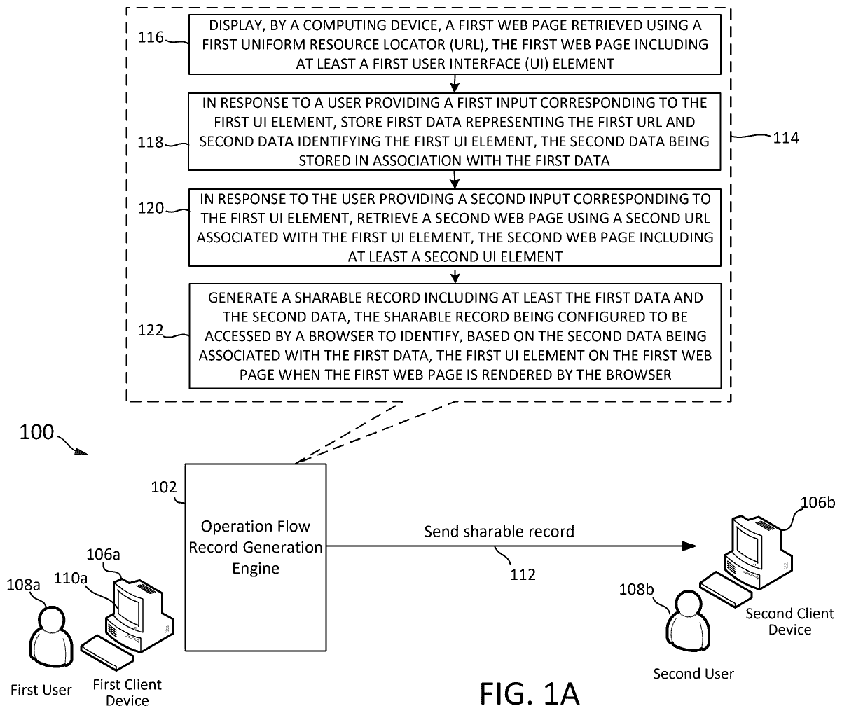

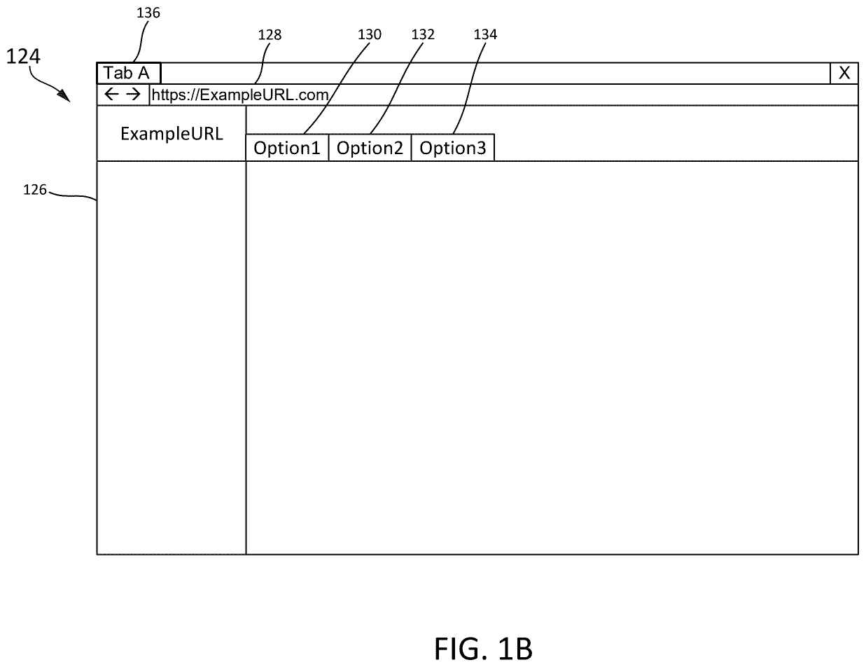

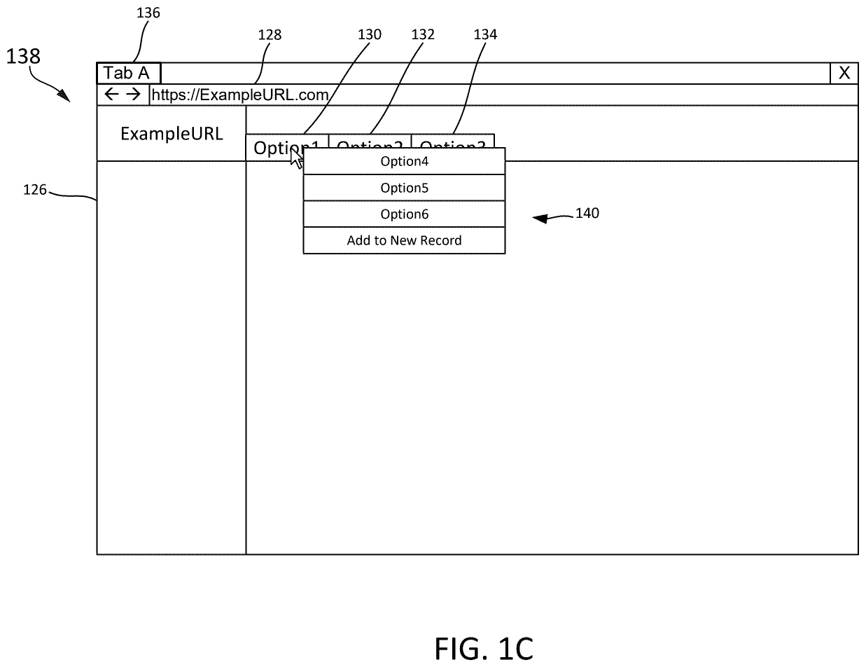

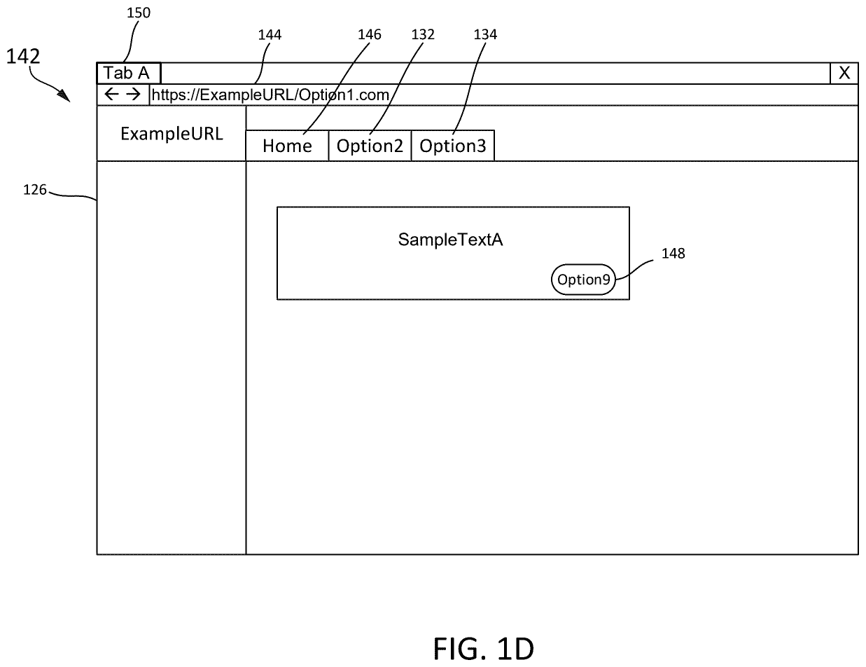

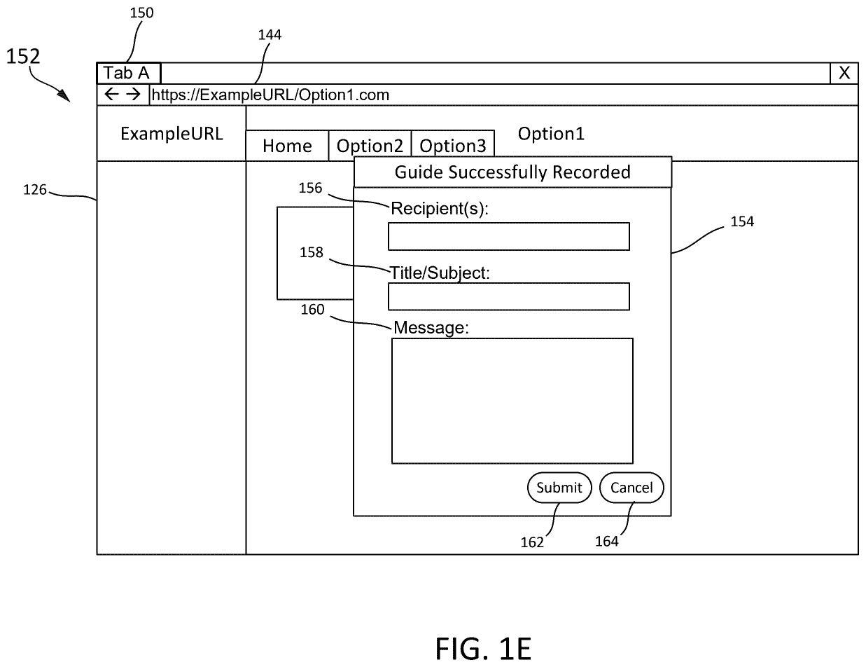

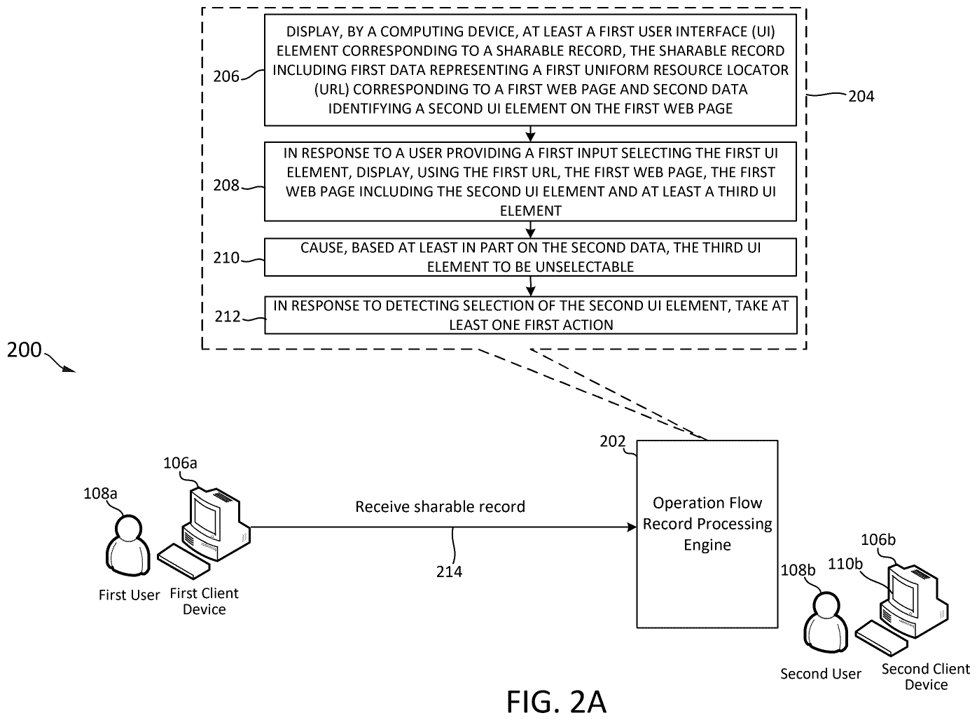

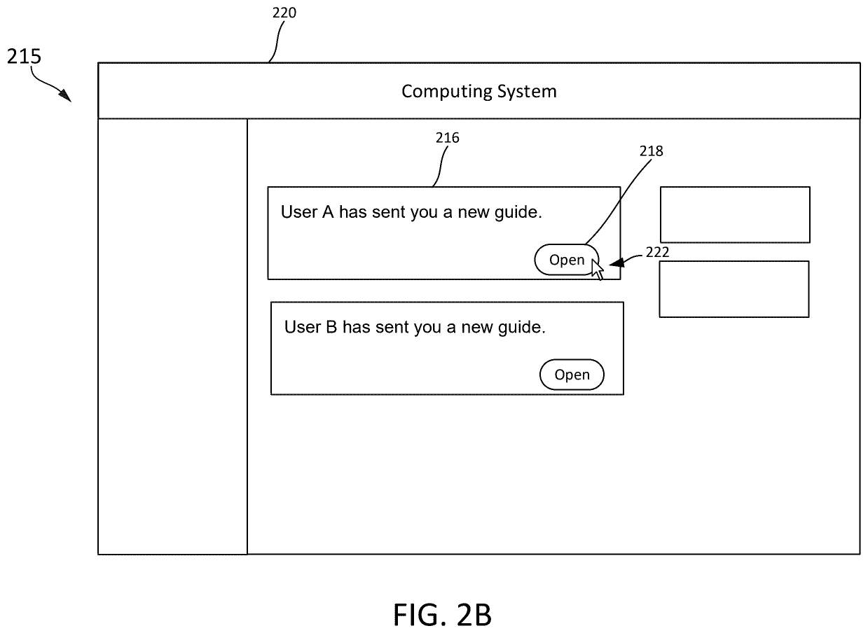

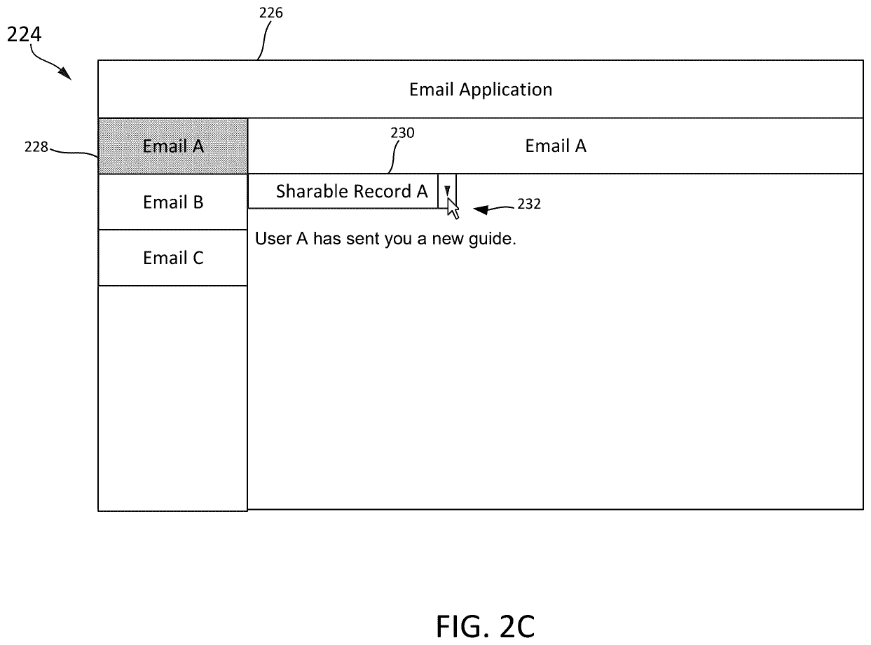

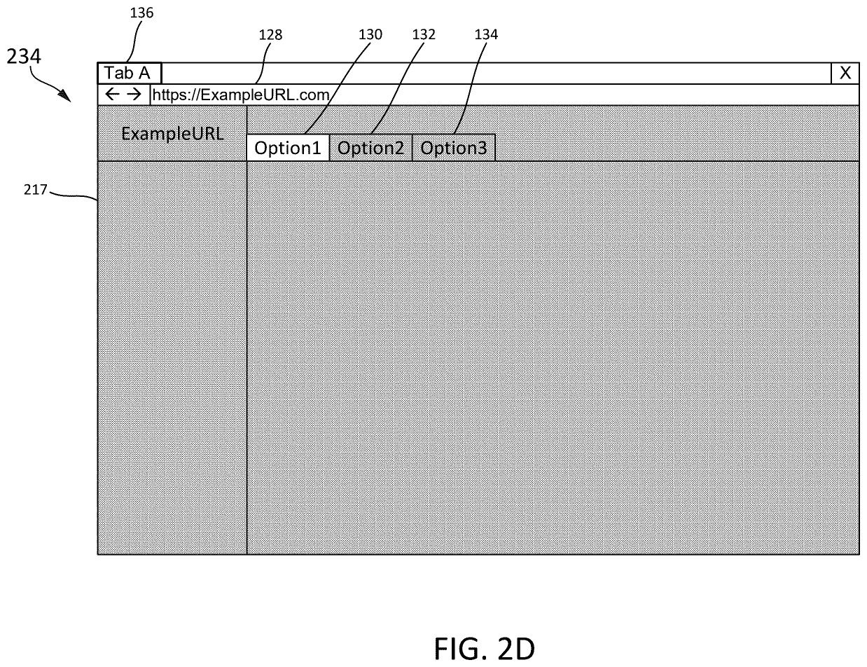

FIG. 1A shows a first example system 100 configured to generate sharable records for performing actions on a web page using a web browsing application. As shown, in some implementations, the system 100 may include an operation flow record generation engine 102 that may be included on a first client device 106a or otherwise be configured to operate under the control of a first user 108a of the first client device 106a. As also illustrated, the operation flow record generation engine 102 may be in communication with a second client device 106b to enable the sending of sharable records (as indicated by an arrow 112) to a second user 108b of the second client device 106b. Example operations that may be performed by an operation flow record processing engine 202 associated with the second client device 106b are described below in connection with FIGS. 2A-C. The first client device 106a and the second client device 106b may each correspond to any one of the clients 302 described in Sections B through E below.

In some implementations, the routine 114 performed by the operation flow record generation engine 102 shown in FIG. 1A may be implemented by one or more processors executing instructions encoded on one or more computer readable mediums. FIGS. 1B-1E show example screens 124, 138, 142, 152, respectively, of the first client device 106a as the operation flow record generation engine 102 performs the steps of the routine 114.

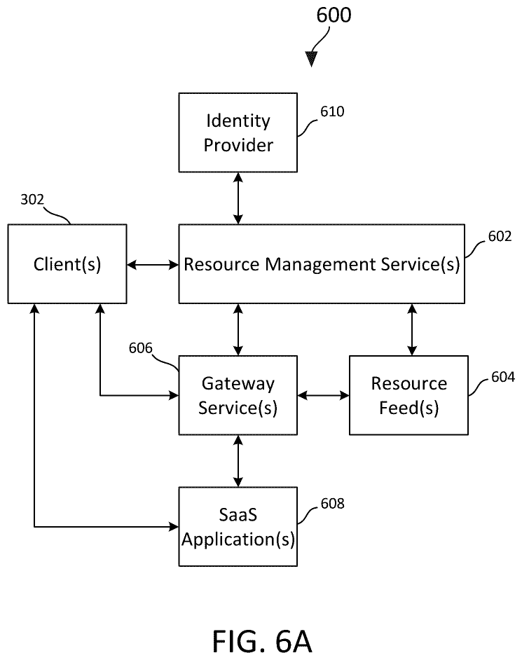

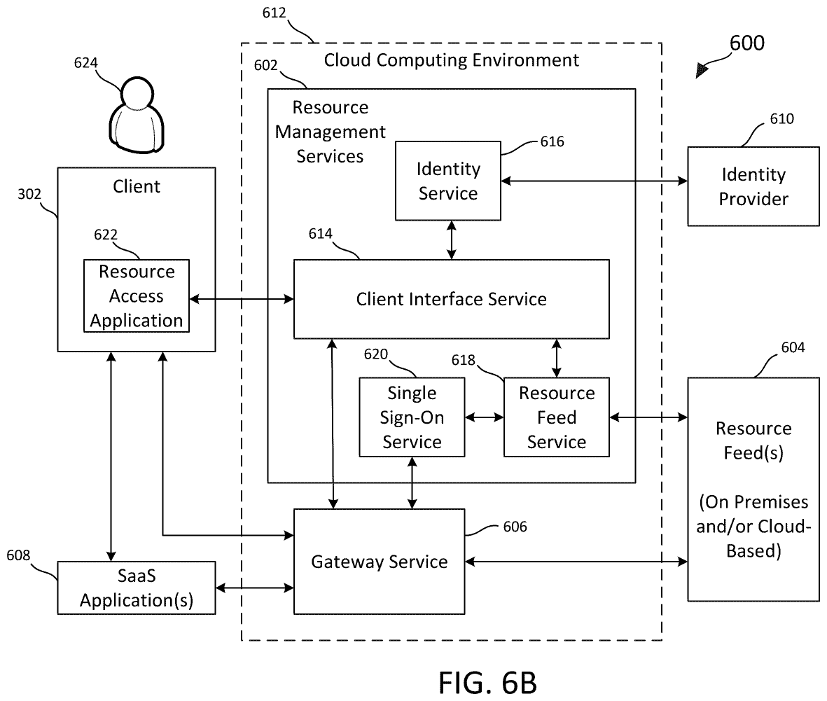

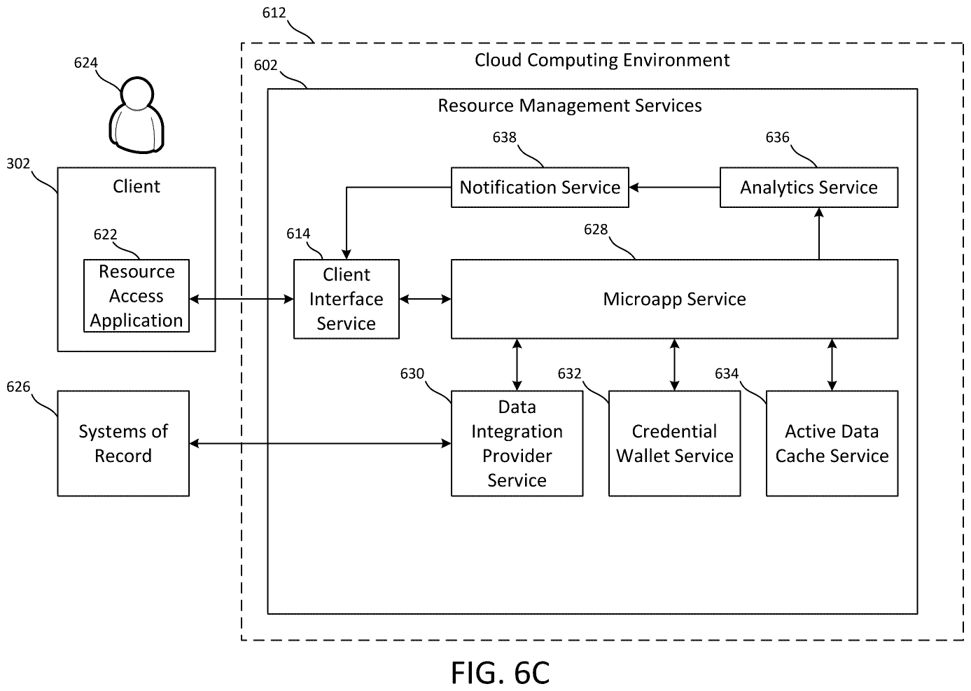

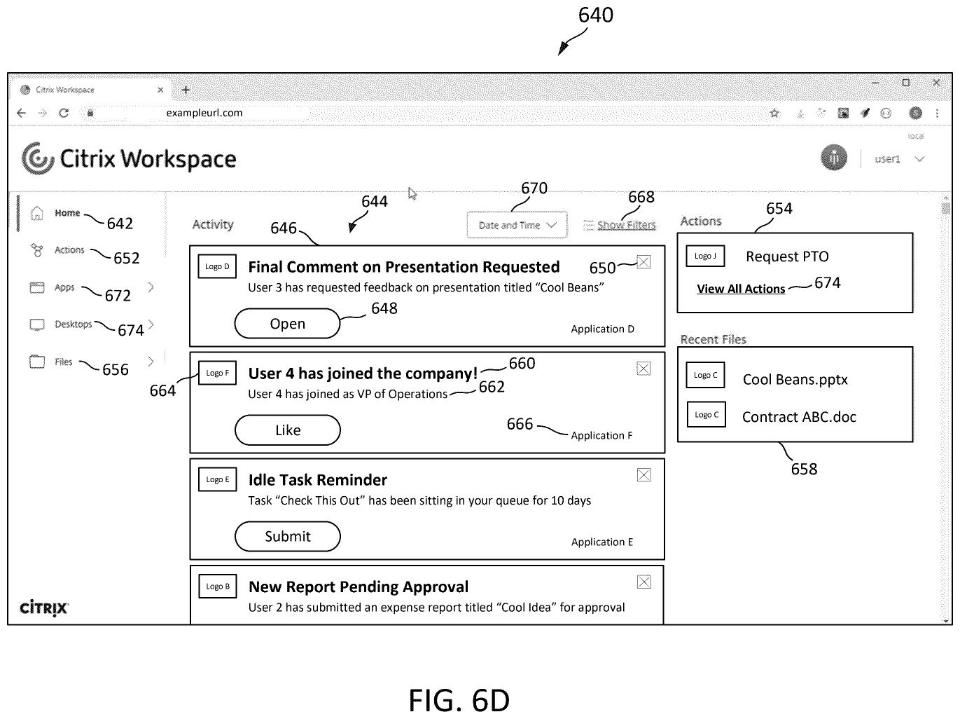

As shown in FIG. 1B, a display 110a (see FIG. 1A) of the first client device 106a may be presenting (as the screen 124) a particular web page in a web browsing application (e.g., a web browser) 126. In some implementations, the operation flow record generation engine 102 may be an extension (e.g., an add-on or plug-in) of the web browser 126. In some implementations, the web browser 126 may be a specialized web browser that is embedded in a resource access application 622 (e.g., when the resource access application 622 is installed on the first client device 106a) or provided by one of the resource feeds 604 (e.g., when the resource access application 622 is located remotely), e.g., via a secure browser service, as described below in connection with FIGS. 6A-C. In other implementations, the web browser 126 may instead be a standard web browser, such as a Google Chrome browser or a Mozilla Firefox browser.

As also shown in FIG. 1B, the web browser 126 may present a web page 136 (“Tab A” in the illustrated example) and a web page address bar 128 (populated with “https://ExampleURL.com” in the illustrated example) representing the web page address of the web page 136 currently displayed on the screen 124. The web page 136 may, for example, include one or more selectable UI elements 130, 132, and 134.

As shown in FIG. 1A, in some implementations, the routine 114 may begin at a step 116, when a computing device (e.g., the first client device 106a) displays a first web page retrieved using a first uniform resource locator (URL), the first web page including at least a first user interface (UI) element. For example, with reference to FIG. 1B, the first web page may be the web page 136, the first URL may be the web address contained in the web page address bar 128, and the first UI element may be the UI element 130. The first UI element 130 may be associated with a second URL such that, in response to selection of the first UI element 130, the web browser 126 may retrieve a second web page corresponding to the second URL.

Following the step 116, the routine 114 may proceed to a step 118, at which, in response to the first user 108a providing a first input corresponding to the first UI element 130, the operation flow record generation engine 102 may store first data representing the first URL (e.g., the web address contained in the web page address bar 128) and second data identifying the first UI element 130, the second data being stored in association with the first data. For example, as illustrated by the screen 138 in FIG. 1C, the first user 108a may operate the first client device 106a to provide the first input (e.g., a mouse click, key press, long-press touchscreen input, etc.). In response, the operation flow record generation engine 102 may determine the first URL corresponding to the web page 136 from the web page address bar 128, and may determine second data identifying the first UI element 130. In some implementations, the second data identifying the first UI element 130 may be a unique identifier associated with the first UI element 130. For example, the second data may be an element identifier or an XPath corresponding to the first UI element 130. The XPath corresponding to the first UI element 130 may represent a path through a Document Object Model (DOM) corresponding to the first web page 136. The DOM corresponding to the first web page 136 may be a logical, hierarchical representation of the various objects (e.g., UI elements) of the first web page 136.

In some implementations, prior to the first user 108a providing the first input of the step 118, the operation flow record generation engine 102 may present the first user 108a with one or more options corresponding to the first UI element 130. For example, as shown in FIG. 1C, the operation flow record generation engine 102 may present the first user 108a with a drop-down menu 140 including the one or more options. The drop-down menu 140 may be presented, for example, in response to the user taking a particular action (e.g., a right mouse click) to select the first UI element 130. The drop-down menu 140 may include an option to add the first UI element 130 to a sharable record. In some implementations, if the first user 108a has not previously indicated that they intend to create a sharable record, the drop-down menu 140 may include an option to add the first UI element 130 to a new sharable record, whereas if the first user 108a has previously indicated that they intend to create a sharable record, and the first user 108a has previously added a UI element to the sharable record, then the drop-down menu 140 may instead include an option to add the first UI element 130 to an existing sharable record. In either case, the selection of the option concerning the shareable record may correspond to the first input of the step 118 of the routine 114.

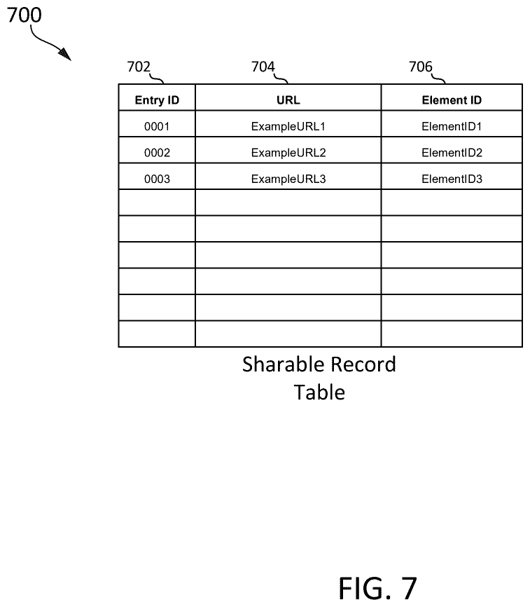

In some implementations, the first input of the step 118 may alternatively correspond to selection of the first UI element 130 so as to retrieve a web page corresponding to that UI element, such as by providing a primary mouse click (e.g., left mouse click) to the UI element 130, without requiring the first user 108a to take a separate action (e.g., a right mouse click) selecting the UI element 130 to obtain the drop-down menu 140. For example, in some implementations, the first user 108a may have previously indicated that a sharable record is to be generated based on such user inputs, and the operation flow record generation engine 102 may simply record the first data and the second data of the step 118 whenever such a UI element is selected. In such implementations, the first input of the step 118 and the second input of the step 120 (described below) may correspond to the same input, e.g., a left mouse click selecting the UI element 130. In either case, as a part of the step 118, the operation flow record generation engine 102 may, in some implementations, store the first data and the second data in a sharable record table 700 (shown in FIG. 7) representing the sharable record (described in more detail below in Section F).

In some implementations, the operation flow record generation engine 102 may additionally or alternatively cause the web browser 126 to present a selectable UI element to the first user 108a which may be selected (or toggled) by the first user 108a to indicate that the first user 108a intends to provide an input corresponding to a UI element to be added to a new/existing sharable record. Based on selection of the selectable UI element, the operation flow record generation engine 102 may determine the first and second data in response to receiving a subsequent input corresponding to a UI element, e.g., the first UI element 130. Such subsequent input may either be an action selecting the UI element, e.g., a left mouse click, that causes a web page corresponding to that UI element to be retrieved, or may be another action selecting the UI element, e.g. a right mouse click, that indicates that the selected UI element is to be represented in the sharable record without also causing the web page corresponding to that UI element to be retrieved.

In some implementations, the operation flow record generation engine 102 may determine the first user 108a has provided the first input using an event handler. Such an event handler may be used, for example, to determine if a specific input event occurs and/or if an event occurs to a specific UI element. In some implementations, the operation flow record generation engine 102 may register for an event handler corresponding to particular inputs. For example, if the first user 108a selects an item using a particular input (e.g., a mouse click, key press, touchscreen input, etc.), the operation flow record generation engine 102 may determine that the input occurred with respect to a particular UI element, and determine the second data accordingly.

At a step 120 of the routine 114, in response to the first user 108a providing a second input corresponding to the first UI element 130, the operation flow record generation engine 102 (e.g., as part of a web browser) may retrieve a second web page using a second URL associated with the first UI element 130, the second web page including at least a second UI element. As shown in FIG. 1D, the display 110a of the first client device 106a may present (as the screen 142) a second web page 150 retrieved by the operation flow record generation engine 102 in response to the first user 108a providing the second input corresponding to the first UI element 130. As shown in FIG. 1D, the second web page 150 may include UI elements 132, 134, 146, 148.

In some implementations, the second input corresponding to the first UI element 130 may be any input (e.g., a mouse click, key press, short-press touchscreen input, etc.) selecting the first UI element 130. As noted above, in some implementations, the second input of the step 120 may correspond to a different action than the first input of the step 118. For example, in some implementations, the first input of the step 118 may correspond to the selection of an option from the drop-down menu 140 (shown in FIG. 1C) obtained by providing a secondary mouse click (e.g., a right mouse click) with respect to the UI element 130, and the second input of the step 120 may correspond to a left click action selecting the UI element 130. In other implementations, as also noted above, the second input of the step 120 may correspond to the same action as the first input of the step 118. For example, in some implementations, the first input of the step 118 and the second input of the step 120 may both correspond to a left click action selecting the first UI element 130. In either case, as noted above, the first UI element 130 may be associated with the second URL such that, in response to selection of the first UI element 130, the web browser 126 may retrieve the second web page 150.

After retrieving the second web page 150, the first user 108a may further provide one or more additional input(s) with respect to the UI elements 132, 134, 146, 148, and, in response, the operation flow record generation engine 102 may determine additional data representing the second URL (e.g., corresponding to the web address include in the web address bar 144) corresponding to the second web page 150 and additional data corresponding to the selected UI element(s) 132, 134, 146, 148 to store in the sharable record. The first user 108a may thus identify one or more additional UI element(s) across one or more additional web page(s), and, in response, the operation flow record generation engine 102 may determine additional data representing URL(s) corresponding to the web page(s) and additional data corresponding to the UI element(s) selected on such web page(s) to store in the sharable record.

At a step 122 of the routine 114, the operation flow record generation engine 102 may generate a sharable record including at least the first data and the second data, the sharable record being configured to be accessed by a browser to identify, based on the second data being associated with the first data, the first UI element 130 on the first web page 136 when the first web page 136 is rendered by the browser 126.

In some implementations, the operation flow record generation engine 102 may proceed to the step 122 of the routine 114 in response to the first user 108a providing an input indicating that the first user 108a has completed adding operation flow steps (e.g., inputs corresponding to UI elements) to the sharable record. For example, the input may correspond to a mouse click, key press, touchscreen input, etc. As one example, the user may right click on a UI element to obtain a drop down menu similar to the drop-down menu 140 (shown in FIG. 1C) and select an option indicating that the sharable record is complete. As another example, the input may correspond to a selection (or a toggle) of a selectable UI element previously selected by the first user 108a (as described above in connection with FIG. 1C) to indicate a desire to cease adding data to the sharable record.

In some implementations, in response to the input indicating that the first user 108a has completed adding operation flow steps to the sharable record, the operation flow record generation engine 102 may cause the web browser 126 to present a completion screen 152 (as shown in FIG. 1E).

As shown in FIG. 1E, in some implementations, the completion screen 152 may include a completion window 154 including a “recipient(s)” text field UI element 156, a “title/subject” text field UI element 158, a “message” text field UI element 160, a completion button 162, and a cancelation button 164.

The “recipient(s)” text field UI element 156 may be used to enter contact information associated with recipient user(s), e.g., the second user 108b, to whom the first user 108a intends to send the sharable record. For example, the contact information may include an email address, a phone number, a user identifier associated with a social media application, a user identifier associated with a messaging application, a user identifier associated with a multi-resource access system 600 (as described below in Section E, in connection with FIGS. 6A-6D), or any other information that may be used to send the sharable record to the identified recipient user(s).

The “title/subject” text field UI element 158 may be used to enter a title and/or subject that represents, for example, the website/application associated with the sharable record and/or the type of actions to be performed with respect to the website/application.

The “message” text field UI element 160 may be used to enter a message associated with the sharable record. For example, the message may include details associated with the actions to be performed or any other additional information a recipient of the sharable record may find useful.

The completion button 162 may be used to send the sharable record to the recipient(s) identified in the “recipient(s)” text field UI element 156, where the sharable record may be sent along with the title/subject and the message identified in the “title/subject” text field UI element 158 and the “message” text field UI element 160, respectively. For example, in response to determining that the first user 108a has selected the completion button 162, the operation flow record generation engine 102 may determine the contact information contained in the “recipient(s)” text field UI element 156 and send the sharable record to the recipient(s) using the contact information.

In some implementations, the completion screen 152 may additionally or alternatively prompt the first user 108a to provide a name for the sharable record and possibly also specify a storage location (e.g., a folder) to which the sharable record is to be stored. Selection of the completion button 162 in such an implementation may cause the sharable record to be stored at the specified location as a file having the specified name. Such a file may thereafter be selected and sent to one or more recipient users, e.g., to the second client device 106b operated by the second user 108b, in any of a number of ways, e.g., as an attachment to an email, a short message service (SMS) message, a direct message, etc.

The cancelation button 164 may be used to close the completion window 154. For example, in some implementations, if the first user 108a wishes to continue to add actions to the sharable record, the first user 108a may select the cancelation button 164 and continue to identify actions to add to the sharable record. In other implementations, upon selection of the cancelation button 164, the operation flow record generation engine 102 may close the completion window 154 and delete the sharable record.

As shown in FIG. 1A, as indicated by an arrow 112, the operation flow record generation engine 102 may send the sharable record to the second client device 106b. As noted above, in some implementations, the operation flow record generation engine 102 may send the sharable record to the second client device 106b using the contact information included in the “recipient(s)” text field UI element 156 of the completion window 154. In other implementations, as also noted above, the first user 108a may additionally or alternatively separately compose and address a message to the second user 108b (e.g., an email, an SMS message, a direct message, etc.), and may append the sharable record as an attachment to such a message.

In some implementations, e.g., where the operation flow record generation engine 102 is an extension of a specialized web browser that is embedded in a resource access application 622, the operation flow record generation engine 102 may use a user identifier associated with the multi-resource access system 600 (e.g., see FIG. 6C) to instruct the notification service 638 to send the sharable record as a notification 646 to be included in an activity feed 644 of the recipient user.

FIG. 2A shows an example system 200 configured to process sharable records for performing actions using a web browser. As shown, in some implementations, the system 200 may include an operation flow record processing engine 202 that may be included on the second client device 106b or otherwise be configured to operate under the control of the second user 108b of the second client device 106b.

As also illustrated, in some implementations, the system 200 may enable the receiving of a sharable record (as indicated by an arrow 214). The operation flow record processing engine 202 may use the sharable record to provide a guided walkthrough of the steps represented in the sharable record to the second user 108b of the second client device 106b. In some implementations, as illustrated, the operation flow record processing engine 202 may be configured to perform a routine 204. In some implementations, the routine 204 may be implemented by one or more processors executing instructions encoded on one or more computer readable mediums. FIGS. 2B, 2C, and 2D show example screens 215, 224, and 234, respectively, of the second client device 106b as the operation flow record processing engine 202 performs the steps of the routine 204.

As shown in FIG. 2A, in some implementations, the routine 204 may begin at a step 206, at which a computing device (e.g., the second client device 106b) may display at least a first user interface (UI) element corresponding to a sharable record, the sharable record including first data representing a first uniform resource locator (URL) corresponding to a first web page and second data identifying a second UI element on the first web page. For example, as shown in FIG. 2B (as the first example screen 215 of the second client device 106b), the first UI element corresponding to the sharable record may be an “open” button 218 included within a notification 216 presented by an application 220. In some implementations, the application 220 may correspond to a resource access application 622 (as described in detail below in Section E) that is configured to present an activity feed 644 (see FIG. 6D). In such implementations, the notification 216 may be included amongst the notifications 646 that are included in such an activity feed 644.

In some implementations, the sharable record may be executed in response to the second user 108b providing an input 222 selecting the button 218. Although not shown in FIG. 2B, in further implementations, the notification 216 may include a delete button and/or a view button, or the like. The delete button may, for example, allow the second user 108b to close the notification 216 and delete the sharable record. The view button may, for example, allow the second user 108b to view the one or more URLs corresponding to the web pages included in the sharable record. In some implementations, the view button may additionally or alternatively allow the second user 108b to view a title/subject and/or a message associated with the sharable record.

In other implementations, the application 220 may be any other type of application to which a sharable record may be sent, e.g., using contact information corresponding to the recipient user (e.g., an email application, a social media application, a messaging application, etc.), and which is configured to process such a sharable record as described herein. In such implementations, the sharable record may be included as a file attachment to/with a message (e.g., an email, a SMS message, a direct message, etc.), and the first UI element may be the file attachment itself. FIG. 2C shows a second example screen 224 of the second client device 106b that may be presented by the application 220 in such an implementation. As illustrated, the first UI element for the sharable record may be a file attachment 230 of an email 228 that can be accessed via an email application 226. In some implementations, the sharable record may be executed in response to the second user 108b providing an input 232 selecting the file attachment 230, e.g., by double-clicking on it.

In response to the second user 108b providing a first input (e.g. the input 222 as shown in FIG. 2B, the input 232 as shown in FIG. 2C, etc.) selecting the first UI element (e.g., the button 218 of the notification 216 shown in FIG. 2B, the file attachment 230 shown in FIG. 2C, etc.), the operation flow record processing engine 202 may proceed to a step 208 of the routine 204, at which the operation flow record processing engine 202 may display, using the first URL, the first web page, the first web page including the second UI element and at least a third UI element. For example, as shown in FIG. 2D, the operation flow record processing engine 202 may cause the display 110b of the second client device 106b to present a third example screen 234 corresponding to the first web page 136. The first web page 136 may include the second UI element 130, a third UI element 132, and perhaps one or more additional UI elements 134.

In some implementations, in response to the second user 108b providing the first input (e.g., the input 222, the input 232, etc.), the sharable record (to which the button 218/file attachment 230 corresponds) may automatically cause a web browser 217 to be launched, if it is not already running, and to retrieve the first web page 136 using the first URL included in the sharable record. For example, the sharable record may include data (e.g., a computer programming script) that may cause a default web browser of the second client device 106b to be launched, if necessary, and to retrieve the first web page 136 using the first URL included in the sharable record. In some implementations, if the web browser 217 is already launched, the first web page 136 may be retrieved, using the first URL, in a new tab of the web browser 217.

In other implementations, the second user 108b may manually launch the web browser 217, and the operation flow record processing engine 202 may subsequently detect that the second user 108b has provided the first input (e.g., the input 222, the input 232, etc.).

In some implementations, the sharable record may include data that indicates to the web browser 217 that the web browser 217 is to process the sharable record using specialized code (e.g., an add-in or plug-in embodying the operation flow record processing engine 202). For example, the sharable record may include an identifier or the like that indicates to the web browser 217 that the web browser 217 should use the operation flow record processing engine 202 to process the sharable record.

In some implementations, the web browser 217 may be a specialized web browser that is embedded in the resource access application 622 (e.g., when the resource access application 622 is installed on the second client device 106b) or provided by one of the resource feeds 604 (e.g., when the resource access application 622 is located remotely), e.g., via a secure browser service, as described below in connection with FIGS. 6A-C. In some implementations, the operation flow record generation engine 102 may be an extension (e.g., an add-on or plug-in) of the web browser 217.

At a step 210 of the routine 204, the operation flow record processing engine 202 may, based at least in part on the second data (i.e., identifying the second UI element 130 on the first web page 136), cause one or more UI elements other than the second UI element 130, e.g., the third UI element 132 shown in FIG. 1D, to be un-selectable, while allowing the second UI element 130 to remain selectable. For example, as shown in FIG. 2D, the third UI element 132 and the additional UI element(s) 134 may be made un-selectable (as indicated by the grey overlay), whereas the second UI element 130 may continue to be selectable (as indicated by the absence of the grey overlay).

In some implementations, the operation flow record processing engine 202 may cause such other UI element(s) 132, 134 to become un-selectable, without also causing the second UI element 130 to be made un-selectable. In other implementations, the operation flow record processing engine 202 may first cause the second UI element 130 and the other UI element(s) 132, 134 (and perhaps all of the UI elements on the first web page 136) to become un-selectable, and may thereafter cause the second UI element 130 to be made selectable.

In some implementations, the operation flow record processing engine 202 may cause the third UI element 132 and/or the additional UI element(s) 134 to become un-selectable using a DOM corresponding to the first web page 136. For example, in some implementations, the operation flow record processing engine 202 may cause the third UI element 132 and/or the other UI element(s) 134 to become un-selectable by adding an overlay layer to the DOM corresponding to the first web page 136. The operation flow record processing engine 202 may, for instance, add an overlay layer on top of the third UI element 132 and/or the other UI element(s) 134. The operation flow record processing engine 202 may add the overlay layer on top of the third UI element 132 and/or the other UI element(s) 134 by, for example, manipulating a positioning and/or stack order of the overlay layer and/or the UI element(s) 132, 134 within the DOM corresponding to the first web page 136 (e.g., using a z-index of the overlay layer and/or the UI element(s) 132, 134). Adding the overlay layer on top of the of the UI element(s) 132, 134 may cause any input attempting to select such UI element(s) 132, 134 to instead select the overlay layer, as those UI element 132, 134 would be positioned on a layer underneath the overlay layer.

In some implementations, after adding the overlay layer to the DOM corresponding to the first web page 136 (thus making all of the UI elements 130, 132, 134 on the first web page 136 un-selectable), the operation flow record processing engine 202 may, based at least in part on the second data, cause the second UI element 130 to become selectable. In some implementations, for example, the operation flow record processing engine 202 may use the second data (e.g., an element identifier, an XPath, etc.) to identify the second UI element 130 within the DOM corresponding to the first web page 136, and may manipulate a positioning and/or stack order of the second UI element 130 in the DOM corresponding to the first web page 136 (e.g., a z-index of the second UI element 130), such that the second UI element 130 is positioned on a layer above the overlay layer.

In other implementations, before adding the overlay layer to the DOM corresponding to the first web page 136, the operation flow record processing engine 202 may otherwise use the second data (e.g., an element identifier, an XPath, etc.) to identify the second UI element 130 such that, when the overlay layer is added to the DOM for the first web page 136, the overlay layer covers the third UI element 132 and the other UI element(s) 134, but does not cover the second UI element 130.

In other implementations, the operation flow record processing engine 202 may use the DOM corresponding to the first web page 136 to cause the UI element(s) 132, 134 to become un-selectable, while allowing the second UI element 130 to remain selectable, by configuring attributes of the UI element(s) 132, 134 which correspond to a selection functionality of the UI element(s) 132, 134, when the first web page 136 is rendered by the web browser 217. For example, the operation flow record processing engine 202 may determine an attribute (e.g., a pointer-events attribute and/or a disabled attribute) of the UI element(s) 132, 134, and configure the attribute to cause such UI element(s) 132, 134 to become un-selectable. In some implementations, the operation flow record processing engine 202 may use the second data (e.g., an element identifier, an XPath, etc.) to identify the second UI element 130 and refrain from causing the second UI element 130 to be made un-selectable. In other implementations, the operation flow record processing engine 202 may first configure one or more attributes of the second UI element 130 and the other UI element(s) 132, 134 (and perhaps all of the selectable UI elements on the first web page 136) so as to make them un-selectable, and then use the second data to alter the one or more attributes of the second UI element 130 to make it selectable.

After causing the UI element(s) 132, 134 to become un-selectable, while allowing the second UI element 130 to remain selectable, the second user 108b may provide a second input selecting the second UI element 130 on the first web page 136. At a step 212 of the routine 204, in response to determining that the second user 108b has provided the second input selecting the second UI element 130 on the first web page 136, the operation flow record processing engine 202 may take at least one first action, e.g., by causing a second web page corresponding to the second UI element 130 to be retrieved.

In some implementations, the operation flow record processing engine 202 may thereafter determine whether a URL associated with the second web page corresponds to a next step (e.g., by being identified in another step) of the sharable record. For example the operation flow record processing engine 202 may make such a determination using the sharable record table 700 (described in detail below in Section F). If the URL corresponds to another step in the sharable record, the operation flow record processing engine 202 may perform the steps 210 and 212 of the routine 204, with respect to the second web page (e.g., using the data for the next row of the sharable record table 700). If, instead, the operation flow record processing engine 202 determines that the URL does not correspond to another step in the sharable record, the operation flow record processing engine 202 may cease processing with respect to the sharable record. For example, the operation flow record processing engine 202 may not cause any elements of the second web page to be made un-selectable.

### B. Network Environment

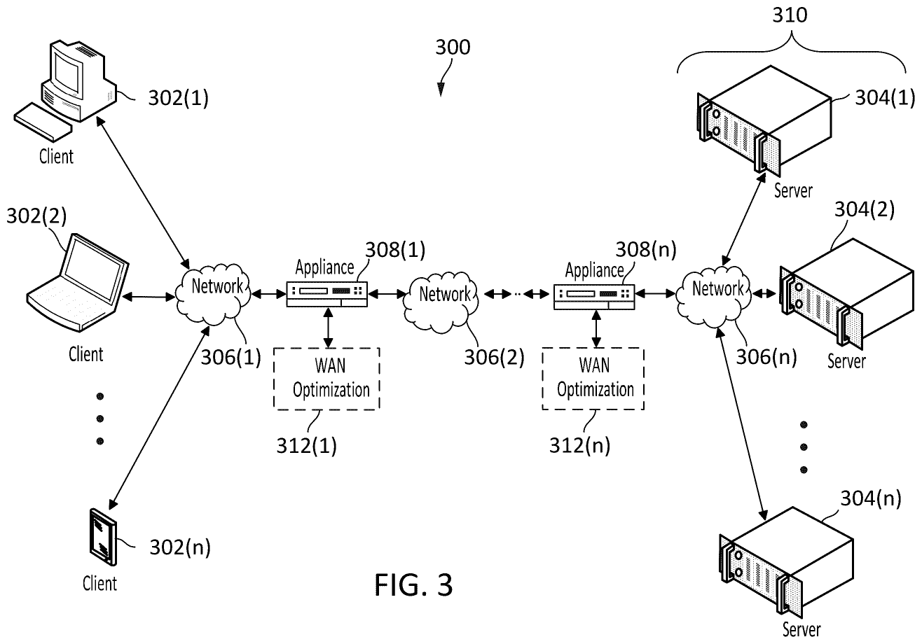

Referring to FIG. 3, an illustrative network environment 300 is depicted. As shown, the network environment 300 may include one or more clients 302(1)-302(n) (also generally referred to as local machine(s) 302 or client(s) 302) in communication with one or more servers 304(1)-304(n) (also generally referred to as remote machine(s) 304 or server(s) 304) via one or more networks 306(1)-306(n) (generally referred to as network(s) 306). In some embodiments, a client 302 may communicate with a server 304 via one or more appliances 308(1)-308(n) (generally referred to as appliance(s) 308 or gateway(s) 308). In some embodiments, a client 302 may have the capacity to function as both a client node seeking access to resources provided by a server 304 and as a server 304 providing access to hosted resources for other clients 302.

Although the embodiment shown in FIG. 3 shows one or more networks 306 between the clients 302 and the servers 304, in other embodiments, the clients 302 and the servers 304 may be on the same network 306. When multiple networks 306 are employed, the various networks 306 may be the same type of network or different types of networks. For example, in some embodiments, the networks 306(1) and 306(n) may be private networks such as local area network (LANs) or company Intranets, while the network 306(2) may be a public network, such as a metropolitan area network (MAN), wide area network (WAN), or the Internet. In other embodiments, one or both of the network 306(1) and the network 306(n), as well as the network 306(2), may be public networks. In yet other embodiments, all three of the network 306(1), the network 306(2) and the network 306(n) may be private networks. The networks 306 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols. In some embodiments, the network(s) 306 may include one or more mobile telephone networks that use various protocols to communicate among mobile devices. In some embodiments, the network(s) 306 may include one or more wireless local-area networks (WLANs). For short range communications within a WLAN, clients 302 may communicate using 802.11, Bluetooth, and/or Near Field Communication (NFC).

As shown in FIG. 3, one or more appliances 308 may be located at various points or in various communication paths of the network environment 300. For example, the appliance 308(1) may be deployed between the network 306(1) and the network 306(2), and the appliance 308(n) may be deployed between the network 306(2) and the network 306(n). In some embodiments, the appliances 308 may communicate with one another and work in conjunction to, for example, accelerate network traffic between the clients 302 and the servers 304. In some embodiments, appliances 308 may act as a gateway between two or more networks. In other embodiments, one or more of the appliances 308 may instead be implemented in conjunction with or as part of a single one of the clients 302 or servers 304 to allow such device to connect directly to one of the networks 306. In some embodiments, one or more appliances 308 may operate as an application delivery controller (ADC) to provide one or more of the clients 302 with access to business applications and other data deployed in a datacenter, the cloud, or delivered as Software as a Service (SaaS) across a range of client devices, and/or provide other functionality such as load balancing, etc. In some embodiments, one or more of the appliances 308 may be implemented as network devices sold by Citrix Systems, Inc., of Fort Lauderdale, FL, such as Citrix Gateway™ or Citrix ADC™.

A server 304 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 304 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 304 may execute a remote presentation services program or other program that uses a thin-client or a remote-display protocol to capture display output generated by an application executing on a server 304 and transmit the application display output to a client device 302.

In yet other embodiments, a server 304 may execute a virtual machine providing, to a user of a client 302, access to a computing environment. The client 302 may be a virtual machine. The virtual machine may be managed by, for example, a hypervisor, a virtual machine manager (VMM), or any other hardware virtualization technique within the server 304.

As shown in FIG. 3, in some embodiments, groups of the servers 304 may operate as one or more server farms 310. The servers 304 of such server farms 310 may be logically grouped, and may either be geographically co-located (e.g., on premises) or geographically dispersed (e.g., cloud based) from the clients 302 and/or other servers 304. In some embodiments, two or more server farms 310 may communicate with one another, e.g., via respective appliances 308 connected to the network 306(2), to allow multiple server-based processes to interact with one another.

As also shown in FIG. 3, in some embodiments, one or more of the appliances 308 may include, be replaced by, or be in communication with, one or more additional appliances, such as WAN optimization appliances 312(1)-312(n), referred to generally as WAN optimization appliance(s) 312. For example, WAN optimization appliances 312 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, one or more of the appliances 312 may be a performance enhancing proxy or a WAN optimization controller.

In some embodiments, one or more of the appliances 308, 312 may be implemented as products sold by Citrix Systems, Inc., of Fort Lauderdale, FL, such as Citrix SD-WAN™ or Citrix Cloud™. For example, in some implementations, one or more of the appliances 308, 312 may be cloud connectors that enable communications to be exchanged between resources within a cloud computing environment and resources outside such an environment, e.g., resources hosted within a data center of+ an organization.

### C. Computing Environment

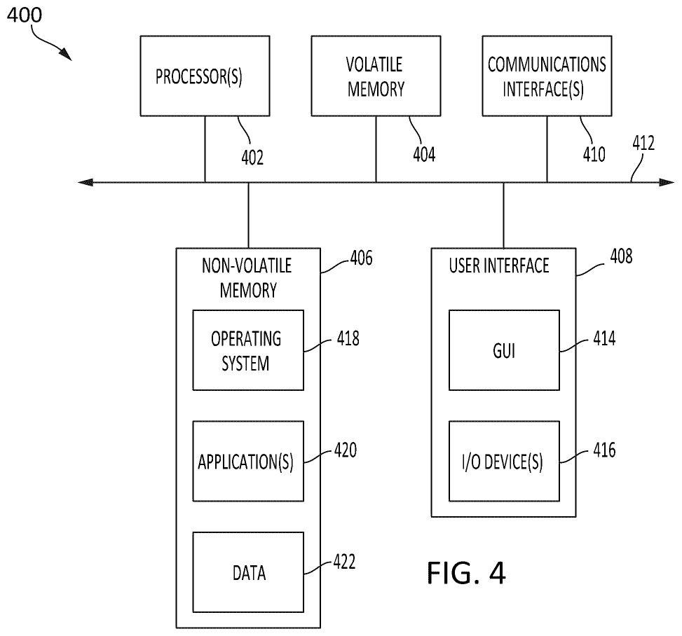

FIG. 4 illustrates an example of a computing system 400 that may be used to implement one or more of the respective components (e.g., the clients 302, the servers 304, the appliances 308, 312, etc.) within the network environment 300 shown in FIG. 3. As shown in FIG. 4, the computing system 400 may include one or more processors 402, volatile memory 404 (e.g., RAM), non-volatile memory 406 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), a user interface (UI) 408, one or more communications interfaces 410, and a communication bus 412. The user interface 408 may include a graphical user interface (GUI) 414 (e.g., a touchscreen, a display, etc.) and one or more input/output (I/O) devices 416 (e.g., a mouse, a keyboard, etc.). The non-volatile memory 406 may store an operating system 418, one or more applications 420, and data 422 such that, for example, computer instructions of the operating system 418 and/or applications 420 are executed by the processor(s) 402 out of the volatile memory 404. Data may be entered using an input device of the GUI 414 or received from I/O device(s) 416. Various elements of the computing system 400 may communicate via communication with the bus 412. The computing system 400 as shown in FIG. 4 is shown merely as an example, as the clients 302, servers 304 and/or appliances 308 and 312 may be implemented by any computing or processing environment and with any type of machine or set of machines that may have suitable hardware and/or software capable of operating as described herein.

The processor(s) 402 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

The communications interfaces 410 may include one or more interfaces to enable the computing system 400 to access a computer network such as a Local Area Network (LAN), a Wide Area Network (WAN), a Personal Area Network (PAN), or the Internet through a variety of wired and/or wireless connections, including cellular connections.

As noted above, in some embodiments, one or more computing systems 400 may execute an application on behalf of a user of a client computing device (e.g., a client 302 shown in FIG. 3), may execute a virtual machine, which provides an execution session within which applications execute on behalf of a user or a client computing device (e.g., a client 302 shown in FIG. 3), such as a hosted desktop session, may execute a terminal services session to provide a hosted desktop environment, or may provide access to a computing environment including one or more of: one or more applications, one or more desktop applications, and one or more desktop sessions in which one or more applications may execute.

### D. Systems and Methods for Delivering Shared Resources Using a Cloud Computing Environment

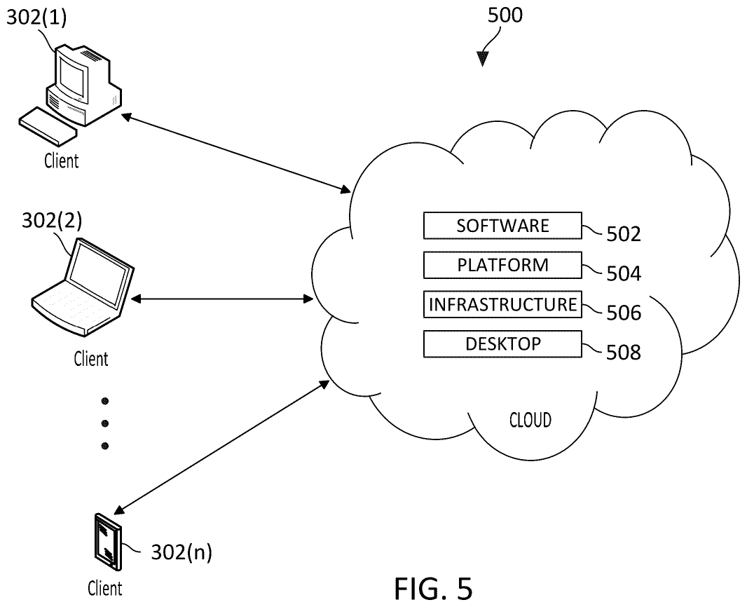

Referring to FIG. 5, a cloud computing environment 500 is depicted, which may also be referred to as a cloud environment, cloud computing or cloud network. The cloud computing environment 500 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 500, one or more clients 302 (such as those described in connection with FIG. 3) are in communication with a cloud network 504. The cloud network 504 may include back-end platforms, e.g., servers, storage, server farms and/or data centers. The clients 302 may correspond to a single organization/tenant or multiple organizations/tenants. More particularly, in one example implementation, the cloud computing environment 500 may provide a private cloud serving a single organization (e.g., enterprise cloud). In another example, the cloud computing environment 500 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, the cloud computing environment 500 may provide a hybrid cloud that is a combination of a public cloud and one or more resources located outside such a cloud, such as resources hosted within one or more data centers of an organization. Public clouds may include public servers that are maintained by third parties to the clients 302 or the enterprise/tenant. The servers may be located off-site in remote geographical locations or otherwise. In some implementations, one or more cloud connectors may be used to facilitate the exchange of communications between one more resources within the cloud computing environment 500 and one or more resources outside of such an environment.

The cloud computing environment 500 can provide resource pooling to serve multiple users via clients 302 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 500 can provide on-demand self-service to unilaterally provision computing capabilities (e.g., server time, network storage) across a network for multiple clients 302. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 500 can provide an elasticity to dynamically scale out or scale in response to different demands from one or more clients 302. In some embodiments, the cloud computing environment 500 may include or provide monitoring services to monitor, control and/or generate reports corresponding to the provided shared services and resources.

In some embodiments, the cloud computing environment 500 may provide cloud-based delivery of different types of cloud computing services, such as Software as a service (SaaS) 502, Platform as a Service (PaaS) 504, Infrastructure as a Service (IaaS) 506, and Desktop as a Service (DaaS) 508, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS platforms include AMAZON WEB SERVICES provided by Amazon.com, Inc., of Seattle, Washington, Azure IaaS provided by Microsoft Corporation or Redmond, Washington, RACKSPACE CLOUD provided by Rackspace US, Inc., of San Antonio, Texas, Google Compute Engine provided by Google Inc., of Mountain View, California, and RIGHTSCALE provided by RightScale, Inc., of Santa Barbara, California.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc., of San Francisco, California.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc., of San Francisco, California, or OFFICE 365 provided by Microsoft Corporation. Examples of SaaS may also include data storage providers, e.g. Citrix ShareFile® from Citrix Systems, DROPBOX provided by Dropbox, Inc., of San Francisco, California, Microsoft SKYDRIVE provided by Microsoft Corporation, Google Drive provided by Google Inc., or Apple ICLOUD provided by Apple Inc., of Cupertino, California.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure, such as AZURE CLOUD from Microsoft Corporation of Redmond, Washington, or AMAZON WEB SERVICES provided by Amazon.com, Inc., of Seattle, Washington, for example. In the case of Citrix Cloud, Citrix Workspace app may be used as a single-entry point for bringing apps, files and desktops together (whether on-premises or in the cloud) to deliver a unified experience.

### E. Systems and Methods for Managing and Streamlining Access by Client Devices to a Variety of Resources

FIG. 6A is a block diagram of an example multi-resource access system 600 in which one or more resource management services 602 may manage and streamline access by one or more clients 302 to one or more resource feeds 604 (via one or more gateway services 606) and/or one or more software-as-a-service (SaaS) applications 608. In particular, the resource management service(s) 602 may employ an identity provider 610 to authenticate the identity of a user of a client 302 and, following authentication, identify one of more resources the user is authorized to access. In response to the user selecting one of the identified resources, the resource management service(s) 602 may send appropriate access credentials to the requesting client 302, and the client 302 may then use those credentials to access the selected resource. For the resource feed(s) 604, the client 302 may use the supplied credentials to access the selected resource via a gateway service 606. For the SaaS application(s) 608, the client 302 may use the credentials to access the selected application directly.

The client(s) 302 may be any type of computing devices capable of accessing the resource feed(s) 604 and/or the SaaS application(s) 608, and may, for example, include a variety of desktop or laptop computers, smartphones, tablets, etc. The resource feed(s) 604 may include any of numerous resource types and may be provided from any of numerous locations. In some embodiments, for example, the resource feed(s) 604 may include one or more systems or services for providing virtual applications and/or desktops to the client(s) 302, one or more file repositories and/or file sharing systems, one or more secure browser services, one or more access control services for the SaaS applications 608, one or more management services for local applications on the client(s) 302, one or more internet enabled devices or sensors, etc. The resource management service(s) 602, the resource feed(s) 604, the gateway service(s) 606, the SaaS application(s) 608, and the identity provider 610 may be located within an on-premises data center of an organization for which the multi-resource access system 600 is deployed, within one or more cloud computing environments, or elsewhere.

FIG. 6B is a block diagram showing an example implementation of the multi-resource access system 600 shown in FIG. 6A in which various resource management services 602 as well as a gateway service 606 are located within a cloud computing environment 612. The cloud computing environment may, for example, include Microsoft Azure Cloud, Amazon Web Services, Google Cloud, or IBM Cloud. It should be appreciated, however, that in other implementations, one or more (or all) of the components of the resource management services 602 and/or the gateway service 606 may alternatively be located outside the cloud computing environment 612, such as within a data center hosted by an organization.

For any of the illustrated components (other than the client 302) that are not based within the cloud computing environment 612, cloud connectors (not shown in FIG. 6B) may be used to interface those components with the cloud computing environment 612. Such cloud connectors may, for example, run on Windows Server instances and/or Linux Server instances hosted in resource locations and may create a reverse proxy to route traffic between those resource locations and the cloud computing environment 612. In the illustrated example, the cloud-based resource management services 602 include a client interface service 614, an identity service 616, a resource feed service 618, and a single sign-on service 620. As shown, in some embodiments, the client 302 may use a resource access application 622 to communicate with the client interface service 614 as well as to present a user interface on the client 302 that a user 624 can operate to access the resource feed(s) 604 and/or the SaaS application(s) 608. The resource access application 622 may either be installed on the client 302, or may be executed by the client interface service 614 (or elsewhere in the multi-resource access system 600) and accessed using a web browser (not shown in FIG. 6B) on the client 302.

As explained in more detail below, in some embodiments, the resource access application 622 and associated components may provide the user 624 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When the resource access application 622 is launched or otherwise accessed by the user 624, the client interface service 614 may send a sign-on request to the identity service 616. In some embodiments, the identity provider 610 may be located on the premises of the organization for which the multi-resource access system 600 is deployed. The identity provider 610 may, for example, correspond to an on-premises Windows Active Directory. In such embodiments, the identity provider 610 may be connected to the cloud-based identity service 616 using a cloud connector (not shown in FIG. 6B), as described above. Upon receiving a sign-on request, the identity service 616 may cause the resource access application 622 (via the client interface service 614) to prompt the user 624 for the user's authentication credentials (e.g., user-name and password). Upon receiving the user's authentication credentials, the client interface service 614 may pass the credentials along to the identity service 616, and the identity service 616 may, in turn, forward them to the identity provider 610 for authentication, for example, by comparing them against an Active Directory domain. Once the identity service 616 receives confirmation from the identity provider 610 that the user's identity has been properly authenticated, the client interface service 614 may send a request to the resource feed service 618 for a list of subscribed resources for the user 624.

In other embodiments (not illustrated in FIG. 6B), the identity provider 610 may be a cloud-based identity service, such as a Microsoft Azure Active Directory. In such embodiments, upon receiving a sign-on request from the client interface service 614, the identity service 616 may, via the client interface service 614, cause the client 302 to be redirected to the cloud-based identity service to complete an authentication process. The cloud-based identity service may then cause the client 302 to prompt the user 624 to enter the user's authentication credentials. Upon determining the user's identity has been properly authenticated, the cloud-based identity service may send a message to the resource access application 622 indicating the authentication attempt was successful, and the resource access application 622 may then inform the client interface service 614 of the successfully authentication. Once the identity service 616 receives confirmation from the client interface service 614 that the user's identity has been properly authenticated, the client interface service 614 may send a request to the resource feed service 618 for a list of subscribed resources for the user 624.

The resource feed service 618 may request identity tokens for configured resources from the single sign-on service 620. The resource feed service 618 may then pass the feed-specific identity tokens it receives to the points of authentication for the respective resource feeds 604. The resource feeds 604 may then respond with lists of resources configured for the respective identities. The resource feed service 618 may then aggregate all items from the different feeds and forward them to the client interface service 614, which may cause the resource access application 622 to present a list of available resources on a user interface of the client 302. The list of available resources may, for example, be presented on the user interface of the client 302 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®, one or more secure browsers, one or more internet enabled devices or sensors, one or more local applications installed on the client 302, and/or one or more SaaS applications 608 to which the user 624 has subscribed). The lists of local applications and the SaaS applications 608 may, for example, be supplied by resource feeds 604 for respective services that manage which such applications are to be made available to the user 624 via the resource access application 622. Examples of SaaS applications 608 that may be managed and accessed as described herein include Microsoft Office 365 applications, SAP SaaS applications, Workday applications, etc.

For resources other than local applications and the SaaS application(s) 608, upon the user 624 selecting one of the listed available resources, the resource access application 622 may cause the client interface service 614 to forward a request for the specified resource to the resource feed service 618. In response to receiving such a request, the resource feed service 618 may request an identity token for the corresponding feed from the single sign-on service 620. The resource feed service 618 may then pass the identity token received from the single sign-on service 620 to the client interface service 614 where a launch ticket for the resource may be generated and sent to the resource access application 622. Upon receiving the launch ticket, the resource access application 622 may initiate a secure session to the gateway service 606 and present the launch ticket. When the gateway service 606 is presented with the launch ticket, it may initiate a secure session to the appropriate resource feed and present the identity token to that feed to seamlessly authenticate the user 624. Once the session initializes, the client 302 may proceed to access the selected resource.

When the user 624 selects a local application, the resource access application 622 may cause the selected local application to launch on the client 302. When the user 624 selects a SaaS application 608, the resource access application 622 may cause the client interface service 614 to request a one-time uniform resource locator (URL) from the gateway service 606 as well a preferred browser for use in accessing the SaaS application 608. After the gateway service 606 returns the one-time URL and identifies the preferred browser, the client interface service 614 may pass that information along to the resource access application 622. The client 302 may then launch the identified browser and initiate a connection to the gateway service 606. The gateway service 606 may then request an assertion from the single sign-on service 620. Upon receiving the assertion, the gateway service 606 may cause the identified browser on the client 302 to be redirected to the logon page for identified SaaS application 608 and present the assertion. The SaaS may then contact the gateway service 606 to validate the assertion and authenticate the user 624. Once the user has been authenticated, communication may occur directly between the identified browser and the selected SaaS application 608, thus allowing the user 624 to use the client 302 to access the selected SaaS application 608.

In some embodiments, the preferred browser identified by the gateway service 606 may be a specialized browser embedded in the resource access application 622 (when the resource access application 622 is installed on the client 302) or provided by one of the resource feeds 604 (when the resource access application 622 is located remotely), e.g., via a secure browser service. In such embodiments, the SaaS applications 608 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with the client 302 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 604) for assessment of its security risk by a web filtering service. For approved URLs, the specialized browser may be permitted to access the link. For suspicious links, however, the web filtering service may have the client interface service 614 send the link to a secure browser service, which may start a new virtual browser session with the client 302, and thus allow the user to access the potentially harmful linked content in a safe environment.

In some embodiments, in addition to or in lieu of providing the user 624 with a list of resources that are available to be accessed individually, as described above, the user 624 may instead be permitted to choose to access a streamlined feed of event notifications and/or available actions that may be taken with respect to events that are automatically detected with respect to one or more of the resources. This streamlined resource activity feed, which may be customized for individual users, may allow users to monitor important activity involving all of their resources-SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user-interface elements, e.g., “approve,” “deny,” and “see more detail” buttons, allowing a user to take one or more simple actions with respect to events right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 302 to notify a user 624 of something that requires the user's attention (e.g., approval of an expense report, new course available for registration, etc.).

FIG. 6C is a block diagram similar to that shown in FIG. 6B but in which the available resources (e.g., SaaS applications, web applications, Windows applications, Linux applications, desktops, file repositories and/or file sharing systems, and other data) are represented by a single box labeled “systems of record,” and further in which several different services are included within the resource management services block 602. As explained below, the services shown in FIG. 6C may enable the provision of a streamlined resource activity feed and/or notification process for a client 302. In the example shown, in addition to the client interface service 614 discussed above, the illustrated services include a microapp service 628, a data integration provider service 630, a credential wallet service 632, an active data cache service 634, an analytics service 636, and a notification service 638. In various embodiments, the services shown in FIG. 6C may be employed either in addition to or instead of the different services shown in FIG. 6B. Further, as noted above in connection with FIG. 6B, it should be appreciated that, in other implementations, one or more (or all) of the components of the resource management services 602 shown in FIG. 6C may alternatively be located outside the cloud computing environment 612, such as within a data center hosted by an organization.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within the resource access application 622 without having to launch the native application. The system shown in FIG. 6C may, for example, aggregate relevant notifications, tasks, and insights, and thereby give the user 624 a dynamic productivity tool. In some embodiments, the resource activity feed may be intelligently populated by utilizing machine learning and artificial intelligence (AI) algorithms. Further, in some implementations, microapps may be configured within the cloud computing environment 612, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 6C, the systems of record 626 may represent the applications and/or other resources the resource management services 602 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. The resource management services 602, and in particular the data integration provider service 630, may, for example, support REST API, JSON, OData-JSON, and 6ML. As explained in more detail below, the data integration provider service 630 may also write back to the systems of record, for example, using OAuth2 or a service account.

In some embodiments, the microapp service 628 may be a single-tenant service responsible for creating the microapps. The microapp service 628 may send raw events, pulled from the systems of record 626, to the analytics service 636 for processing. The microapp service may, for example, periodically cause active data to be pulled from the systems of record 626.

In some embodiments, the active data cache service 634 may be single-tenant and may store all configuration information and microapp data. It may, for example, utilize a pertenant database encryption key and per-tenant database credentials.

In some embodiments, the credential wallet service 632 may store encrypted service credentials for the systems of record 626 and user OAuth2 tokens.

In some embodiments, the data integration provider service 630 may interact with the systems of record 626 to decrypt end-user credentials and write back actions to the systems of record 626 under the identity of the end-user. The write-back actions may, for example, utilize a user's actual account to ensure all actions performed are compliant with data policies of the application or other resource being interacted with.

In some embodiments, the analytics service 636 may process the raw events received from the microapp service 628 to create targeted scored notifications and send such notifications to the notification service 638.

Finally, in some embodiments, the notification service 638 may process any notifications it receives from the analytics service 636. In some implementations, the notification service 638 may store the notifications in a database to be later served in an activity feed. In other embodiments, the notification service 638 may additionally or alternatively send the notifications out immediately to the client 302 as a push notification to the user 624.

In some embodiments, a process for synchronizing with the systems of record 626 and generating notifications may operate as follows. The microapp service 628 may retrieve encrypted service account credentials for the systems of record 626 from the credential wallet service 632 and request a sync with the data integration provider service 630. The data integration provider service 630 may then decrypt the service account credentials and use those credentials to retrieve data from the systems of record 626. The data integration provider service 630 may then stream the retrieved data to the microapp service 628. The microapp service 628 may store the received systems of record data in the active data cache service 634 and also send raw events to the analytics service 636. The analytics service 636 may create targeted scored notifications and send such notifications to the notification service 638. The notification service 638 may store the notifications in a database to be later served in an activity feed and/or may send the notifications out immediately to the client 302 as a push notification to the user 624.

In some embodiments, a process for processing a user-initiated action via a microapp may operate as follows. The client 302 may receive data from the microapp service 628 (via the client interface service 614) to render information corresponding to the microapp. The microapp service 628 may receive data from the active data cache service 634 to support that rendering. The user 624 may invoke an action from the microapp, causing the resource access application 622 to send an action request to the microapp service 628 (via the client interface service 614). The microapp service 628 may then retrieve from the credential wallet service 632 an encrypted Oauth2 token for the system of record for which the action is to be invoked, and may send the action to the data integration provider service 630 together with the encrypted OAuth2 token. The data integration provider service 630 may then decrypt the OAuth2 token and write the action to the appropriate system of record under the identity of the user 624. The data integration provider service 630 may then read back changed data from the written-to system of record and send that changed data to the microapp service 628. The microapp service 628 may then update the active data cache service 634 with the updated data and cause a message to be sent to the resource access application 622 (via the client interface service 614) notifying the user 624 that the action was successfully completed.

In some embodiments, in addition to or in lieu of the functionality described above, the resource management services 602 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, the resource management services 602 may enable virtual assistance functionality that allows users to remain productive and take quick actions. Users may, for example, interact with the “Virtual Assistant” and ask questions such as “What is Bob Smith's phone number?” or “What absences are pending my approval?” The resource management services 602 may, for example, parse these requests and respond because they are integrated with multiple systems on the back-end. In some embodiments, users may be able to interact with the virtual assistant through either the resource access application 622 or directly from another resource, such as Microsoft Teams. This feature may allow employees to work efficiently, stay organized, and deliver only the specific information they're looking for.

FIG. 6D shows how a display screen 640 presented by a resource access application 622 (shown in FIG. 6C) may appear when an intelligent activity feed feature is employed and a user is logged on to the system. Such a screen may be provided, for example, when the user clicks on or otherwise selects a “home” user interface element 642. As shown, an activity feed 644 may be presented on the screen 640 that includes a plurality of notifications 646 about respective events that occurred within various applications to which the user has access rights. An example implementation of a system capable of providing an activity feed 644 like that shown is described above in connection with FIG. 6C. As explained above, a user's authentication credentials may be used to gain access to various systems of record (e.g., SalesForce, Ariba, Concur, RightSignature, etc.) with which the user has accounts, and events that occur within such systems of record may be evaluated to generate notifications 646 to the user concerning actions that the user can take relating to such events. As shown in FIG. 6D, in some implementations, the notifications 646 may include a title 660 and a body 662, and may also include a logo 664 and/or a name 666 of the system of record to which the notification 646 corresponds, thus helping the user understand the proper context with which to decide how best to respond to the notification 646. In some implementations, one or more filters may be used to control the types, date ranges, etc., of the notifications 646 that are presented in the activity feed 644. The filters that can be used for this purpose may be revealed, for example, by clicking on or otherwise selecting the “show filters” user interface element 668. Further, in some embodiments, a user interface element 670 may additionally or alternatively be employed to select a manner in which the notifications 646 are sorted within the activity feed. In some implementations, for example, the notifications 646 may be sorted in accordance with the “date and time” they were created (as shown for the element 670 in FIG. 6D), a “relevancy” mode (not illustrated) may be selected (e.g., using the element 670) in which the notifications may be sorted based on relevancy scores assigned to them by the analytics service 636, and/or an “application” mode (not illustrated) may be selected (e.g., using the element 670) in which the notifications 646 may be sorted by application type.

When presented with such an activity feed 644, the user may respond to the notifications 646 by clicking on or otherwise selecting a corresponding action element 648 (e.g., “Approve,” “Reject,” “Open,” “Like,” “Submit,” etc.), or else by dismissing the notification, e.g., by clicking on or otherwise selecting a “close” element 650. As explained in connection with FIG. 6C below, the notifications 646 and corresponding action elements 648 may be implemented, for example, using “microapps” that can read and/or write data to systems of record using application programming interface (API) functions or the like, rather than by performing full launches of the applications for such systems of record. In some implementations, a user may additionally or alternatively view additional details concerning the event that triggered the notification and/or may access additional functionality enabled by the microapp corresponding to the notification 646 (e.g., in a separate, pop-up window corresponding to the microapp) by clicking on or otherwise selecting a portion of the notification 646 other than one of the user interface elements 648, 650. In some embodiments, the user may additionally or alternatively be able to select a user interface element either within the notification 646 or within a separate window corresponding to the microapp that allows the user to launch the native application to which the notification relates and respond to the event that prompted the notification via that native application rather than via the microapp.

In addition to the event-driven actions accessible via the action elements 648 in the notifications 646, a user may alternatively initiate microapp actions by selecting a desired action, e.g., via a drop-down menu accessible using the “action” user interface element 652 or by selecting a desired action from a list 654 of available microapp actions. In some implementations, the various microapp actions available to the user 624 logged onto the multi-resource access system 600 may be enumerated to the resource access application 622, e.g., when the user 624 initially accesses the system 600, and the list 654 may include a subset of those available microapp actions. The available microapp actions may, for example, be organized alphabetically based on the names assigned to the actions, and the list 654 may simply include the first several (e.g., the first four) microapp actions in the alphabetical order. In other implementations, the list 654 may alternatively include a subset of the available microapp actions that were most recently or most commonly accessed by the user 624, or that are preassigned by a system administrator or based on some other criteria. The user 624 may also access a complete set of available microapp actions, in a similar manner as the “action” user interface element 652, by clicking on the “view all actions” user interface element 674.

As shown, additional resources may also be accessed through the screen 640 by clicking on or otherwise selecting one or more other user interface elements that may be presented on the screen. For example, in some embodiments, the user may also access files (e.g., via a Citrix ShareFile® platform) by selecting a desired file, e.g., via a drop-down menu accessible using the “files” user interface element 656 or by selecting a desired file from a list 658 of recently and/or commonly used files. Further, in some embodiments, one or more applications may additionally or alternatively be accessible (e.g., via a Citrix Virtual Apps and Desktops™ service) by clicking on or otherwise selecting an “apps” user interface element 672 to reveal a list of accessible applications or by selecting a desired application from a list (not shown in FIG. 6D but similar to the list 658) of recently and/or commonly used applications. And still further, in some implementations, one or more desktops may additionally or alternatively be accessed (e.g., via a Citrix Virtual Apps and Desktops™ service) by clicking on or otherwise selecting a “desktops” user interface element 674 to reveal a list of accessible desktops or by or by selecting a desired desktop from a list (not shown in FIG. 6D but similar to the list 658) of recently and/or commonly used desktops.

The activity feed shown in FIG. 6D provides significant benefits, as it allows a user to respond to application-specific events generated by disparate systems of record without needing to navigate to, launch, and interface with multiple different native applications.

### F. Detailed Description of Example Embodiments of the System for Generating and/or Processing Sharable Records for Performing Actions Using a Web Browsing Application

Section A introduced various systems and techniques for generating sharable records for performing actions using a web browsing application by storing data representing a URL of a web page in association with data identifying a UI element, in response to a user providing an input corresponding to the UI element, and generating a sharable record including the data representing the URL and identifying the UI element, where the sharable record is configured to be accessed by a browser to identify, based on the data identifying the UI element being associated with the data representing the URL, the UI element on the web page when the web page is rendered by the browser.

Further, Section A introduced various systems and techniques for processing sharable records for performing actions using a web browsing application by displaying, by a computing system, a first UI element corresponding to a sharable record including data representing a URL corresponding to a web page and data identifying a second UI element on the web page, in response to a user selecting the first UI element, displaying, using the URL, the web page including the second UI element and at least a third UI element, causing, based at least in part on the data identifying the second UI element, the third UI element to be un-selectable, and in response to detecting selection of the second UI element, taking at least one first action.

FIG. 7 shows an example sharable record table 700 that may embody or be included within a sharable record in accordance with some embodiments of the present disclosure. As seen in FIG. 7, the sharable record table 700 may include, for example, “entry id” entries 702, “URL” entries 704, and “element id” entries 706. In some implementations, each row of the sharable record table 700 may correspond to a step represented in a sharable record.

In some implementations, the “entry id” entries 702 may be unique identifiers assigned by the operation flow record generation engine 102 for respective rows of entries in the sharable record table 700.

In some implementations, the “URL” entries 704 may correspond to URLs corresponding to web pages for respective steps represented in the sharable record (e.g., the respective rows of the sharable record table 700).

In some implementations, the “element id” entries 706 may correspond to unique identifiers of UI elements on web pages that were selected by the first user 108a for the respective steps represented in the sharable record (e.g., the respective rows of the sharable record table 700).

In some implementations, each row of the sharable record table 700 may represent both the UI element (e.g., the UI element with an element identifier corresponding to the “element id” entry 706) that the second user 108b is to select, and the web page on which that UI element is located (e.g., as indicated by the “URL” entry 704 in the same row).

Although not shown in FIG. 7, in some implementations, the sharable record table 700 may further include “message” entries which may indicate messages (e.g., “click on the XYZ element”) that are to be presented on or together with the web pages corresponding to the “URL” entries 704. For example, in some implementations, when creating a step of a sharable record as described above in connection with FIG. 1C, the first user 108a may provide an additional input (e.g., a mouse click, key press, touchscreen input, etc.) which indicates to the operation flow record generation engine 102 that a message is to be associated with the current web page. In some implementations, for instance, the drop-down menu 140 (see FIG. 1C) may include an option to add a message to the sharable record. In response to the first user 108a selecting such an option, the operation flow record generation engine 102 may cause the web browser 126 to present a text field UI element to the first user 108a, which enables the first user 108a to input text corresponding to the message that is to be presented on or together with the current web page. After the first user 108a provides input to the text field UI element, the operation flow record generation engine 102 may store the input text as message data in the sharable record table 700. Such message data may be stored in the sharable record, e.g., as an entry in an additional column of the sharable record table 700, in association with the URL of the web page on which the message is to be presented.

As discussed above in connection with the step 212 of the routine 204 (shown in FIG. 2A), the operation flow record processing engine 202 may determine that the second user 108b has selected the second UI element 130 (shown in FIG. 2D) on the first web page 136. In some implementations, the operation flow record processing engine 202 may make such a determination using an event handler. For example, the operation flow record processing engine 202 may register for an event handler for the second UI element 130, such that once the event is triggered, the operation flow record processing engine 202 may receive a notification of the action. The operation flow record processing engine 202 may then compare an element identifier of the selected UI element with the “element id” entry 706 of the sharable record table 700 for the current step. If the comparison is determined to be a match, the operation flow record processing engine 202 may determine the “URL” entry 704 and the “element id” entry 706 of the next row of the sharable record table 700, and may then compare the URL of the current web page to the “URL” entry 704 for that row. If that comparison is determined to be a match, the operation flow record processing engine 202 may again perform the steps 210 and 212 of the routine 204 with respect to that row of the sharable record table 700.

In other implementations, the operation flow record processing engine 202 may determine whether a new web page has been rendered by the web browser 217. For example, the operation flow record processing engine 202 may register for an event handler associated with the rendering of a web page, such that when the web browser 217 renders a new web page (e.g., in response to the second user 108b selecting the second UI element 130 on the first web page 136), the operation flow record processing engine 202 may receive a notification that a new web page has been rendered. The operation flow record processing engine 202 may then determine the “URL” entry 704 and the “element id” entry 706 of the next row of the sharable record table 700, and may compare the URL of the current web page to the “URL” entry 704 for that row. If the comparison is determined to be a match, the operation flow record processing engine 202 may perform the steps 210 and 212 of the routine 204 with respect to that row of the sharable record table 700. In other implementations, the operation flow record processing engine 202 may instead determine only an element identifier corresponding to the “element id” entry 706 for the next row of the sharable record table 700, and may determine whether that element identifier corresponds to any UI element on the current web page. In response to determining the element identifier corresponds to one of the UI elements on the current web page, the operation flow record processing engine 202 may perform the steps 210 and 212 of the routine 204 with respect to that row of the sharable record table 700.

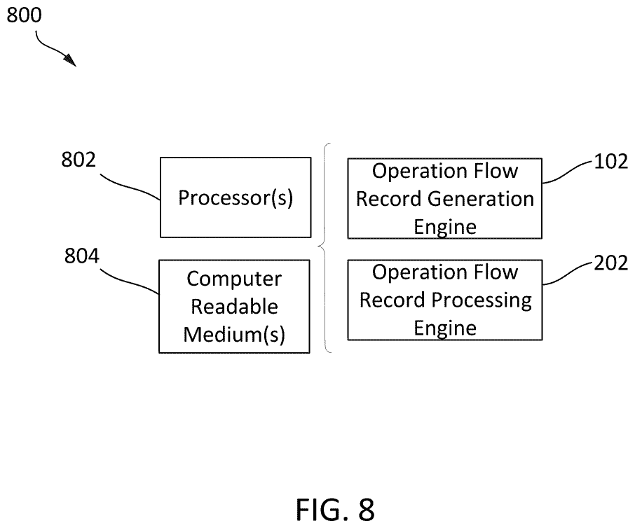

FIG. 8 shows example components 800 that may be included in the systems 100 and 200 that are shown in FIGS. 1A and 2A, respectively. As shown in FIG. 8, in some implementations, the systems 100, 200 may include one or more processors 802 and one or more computer readable mediums 804 that may be encoded with instructions which, when executed by the processor(s) 802 may implement the functionality of the operation flow record generation engine 102 and the operation flow record processing engine 202 (described above).

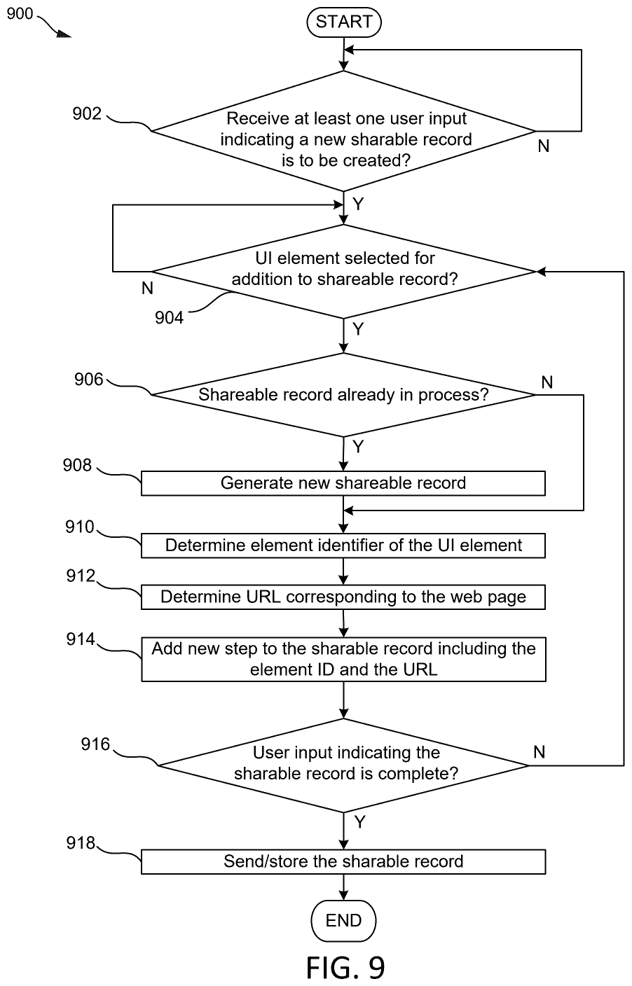

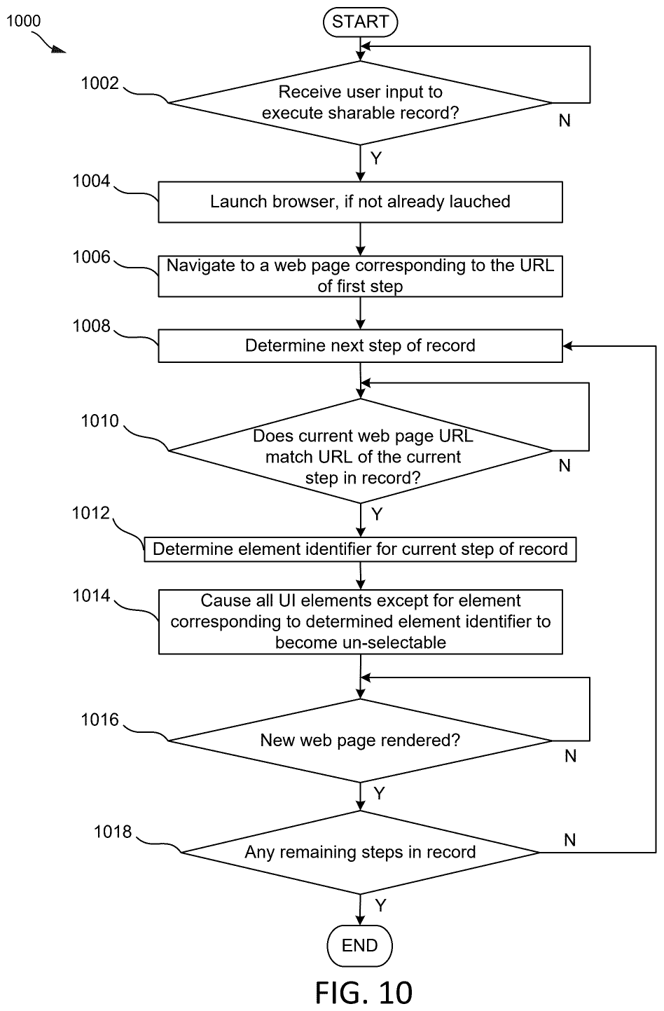

FIG. 9 shows a first example routine 900 that may be performed by the operation flow record generation engine 102. FIG. 10 shows a second example routine 1000 that may be performed by the operation flow record processing engine 202. As explained in more detail below, the routine 900 may be responsible for generating a sharable record for performing actions using a web browsing application. The routine 1000, on the other hand, may be responsible for processing a sharable record for performing actions using a web browsing application.

As shown in FIG. 9, the routine 900 may begin at a decision 902, at which the operation flow record generation engine 102 may determine whether it has received at least one user input indicating a new sharable record is to be created. As discussed in Section A, such user input may be a mouse click, key press, touchscreen input, etc. The operation flow record generation engine 102 may determine that the user input indicates the new sharable record is to be created, for example, by determining whether a selectable UI element has been selected (or toggled) which indicates that the first user 108a intends to provide an input identifying a UI element that is to be added to a new/existing sharable record. As illustrated, when the operation flow record generation engine 102 determines that it has received at least one user input indicating that a new sharable record is to be created, the routine 900 may proceed to a decision 904.

At the decision 904 of the routine 900, the operation flow record generation engine 102 may determine whether a UI element has been selected for addition to the sharable record. For example, the operation flow record generation engine 102 may determine whether an option of a drop-down menu (see drop-down menu 140 of FIG. 1C) for adding a step corresponding to the selected UI element to a new or existing sharable record has been selected. In some implementations, the user input identified at the decision 902 may indicate a new sharable record is to be created and may also result in the operation flow record generation engine 102 determining that a UI element has been selected for addition to the sharable record per the decision 904. When the operation flow record generation engine 102 determines (at the decision 904) that a UI element has been selected for addition to the sharable record, the routine 900 may proceed to a decision 906, at which the operation flow record generation engine 102 may determine whether a shareable record is already in the process of being generated. For example, the operation flow record generation engine 102 may have already generated a shareable record (and added a selected UI element to the generated sharable record) in response to a previous user input, and the first user 108a may be selecting an additional UI element for addition to the existing shareable record.

When, at the decision 906, the operation flow record generation engine 102 determines that a shareable record is not already in the process of being generated, the routine 900 may proceed to a step 908, at which the operation flow record generation engine 102 may generate a new sharable record. As discussed above in connection with FIG. 7, generation of a new sharable record may include generating a new sharable record table 700. When, on the other hand, the operation flow record generation engine 102 determines (at the decision 906) that a shareable record is already in the process of being generated, the routine 900 may instead proceed to a step 910, at which the operation flow record generation engine 102 may determine an element identifier corresponding to the selected UI element.

As noted above, at the step 910 of the routine 900, the operation flow record generation engine 102 may determine an element identifier of the selected UI element. As discussed above in Section A, the element identifier may correspond to an XPath of the UI element within a DOM for the web page, or any other identifier capable of uniquely identifying the UI element on the web page.

At a step 912 of the routine 900, the operation flow record generation engine 102 may determine a URL corresponding to the current web page. For example, the URL may correspond to a web address contained in a web address bar of the web browser (e.g., the web page address bar 128 of the web browser 126 in FIG. 1C).

At a step 914 of the routine 900, the operation flow record generation engine 102 may add a new step to the sharable record which includes the element identifier and the URL (e.g., a new row of entries to the sharable record table 700). For example, the operation flow record generation engine 102 may store the element identifier as an “element id” entry 706 for the new row of the sharable record table 700 and store the URL as a “URL” entry 704 for the new row of the sharable record table 700.

At a decision 916 of the routine 900, the operation flow record generation engine 102 may determine whether the operation flow record generation engine 102 has received a user input indicating that the sharable record is complete (e.g., the first user 108a has finished selecting UI elements to be added to the sharable record). For example, the operation flow record generation engine 102 may determine whether the operation flow record generation engine 102 has received a user input corresponding to a selection (or toggling) of a selectable UI element (discussed above and in Section A) to indicate the sharable record is complete. For further example, the operation flow record generation engine 102 may determine whether the operation flow record generation engine 102 has received a user input corresponding to selection of an option in a drop-down menu (e.g., the drop-down menu 140 shown in FIG. 1C) that indicates the sharable record is complete.

When, at the decision 916 of the routine 900, the operation flow record generation engine 102 determines that a user input indicating that the sharable record is complete (e.g., there are more rows to be added to the sharable record table 700) has not been received, the routine 900 may return to the decision 904. When, on the other hand, the operation flow record generation engine 102 determines that the operation flow record generation engine 102 has received a user input indicating the sharable record is complete (e.g., there are no more rows to be added to the sharable record table 700), the routine 900 may proceed to a step 918, at which the operation flow record generation engine 102 may send the sharable record to another user (e.g., the second user 108b) and/or store the sharable record. For example, as discussed above, in Section A, the operation flow record generation engine 102 may present the first user 108a with a completion screen (see FIG. 1E) into which the first user 108a may provide contact information associated with users to whom the first user 108a wishes to send the sharable record. Once the first user 108a enters the contact information (and selects the completion button 162) the operation flow record generation engine 102 may send the sharable record (e.g., the sharable record table 700) to the identified recipients (e.g., as a file attachment, SMS message, direct message, etc.).

After sending and/or storing the sharable record, the routine 900 may terminate.

As shown in FIG. 10, the routine 1000 may begin at a decision 1002, at which the operation flow record processing engine 202 may determine whether a second user 108b has provided a user input requesting execution of a sharable record. As discussed above, the sharable record may be included in a notification, such as a file attachment, an SMS message, a direct message, etc. In some implementations, the sharable record may additionally or alternatively be represented as a notification 646 in a resource activity feed 644 (see FIG. 6D). The sharable record may be executed in response to the second user 108b providing a user input (e.g., by double-clicking it) which results in execution of the sharable record. When, at the decision 1002, the operation flow record processing engine 202 determines that the second user 108b has provided a user input requesting execution of a sharable record, the routine 1000 may proceed to a step 1004.

At the step 1004 of the routine 1000, a web browser (e.g., the web browser 217) of the second client device 106b may be launched, if it has not already been launched.

At a step 1006 of the routine 1000, the web browser may navigate to a web page corresponding to a URL of the first step of the sharable record. For example, as stated above, in Section A, in some implementations, the sharable record may include data (e.g., a computer programming script) that causes a web browser of the second client device 106b to automatically be launched (if not already launched) and to navigate to the web page corresponding to the URL identified in the first step. As discussed above, the sharable record may include or embody the sharable record table 700 (shown in FIG. 7), and the URL of the first step of the sharable record may correspond to the “URL” entry 704 of the first row of the sharable record table 700. In some implementations, if the web browser is already launched, the web page may be retrieved, using the URL, in a new tab of the web browser.

At a step 1008 of the routine 1000, the operation flow record processing engine 202 may determine a next step in the sharable record (e.g., a next row of entries in the sharable record table 700). In some implementations, if the sharable record has just been executed, in response to the user input detected at the decision 1002, the next step in the sharable record may be the first step in the sharable record (e.g., a first row of entries in the sharable record table 700).

At a decision 1010 of the routine 1000, the operation flow record processing engine 202 may determine whether the URL corresponding to the current web page matches the URL of the current step of the sharable record (e.g., the “URL” entry 704 of the current row of the sharable record table 700). When, at the decision 1010, the operation flow record processing engine 202 determines that the URL corresponding to the current web page does match the URL of the current step of the sharable record, the routine 1000 may proceed to a step 1012, at which the operation flow record processing engine 202 may determine the element identifier for the current step of the sharable record. For example, the operation flow record processing engine 202 may determine the element identifier from the “element id” entry 706 for the current row of the sharable record table 700. As discussed above, in some implementations, the element identifier may correspond to an XPath of the UI element within a DOM for the web page, or any other identifier uniquely identifying the UI element on the web page. In some implementations, the decision 1010 of the routine 1000 need not be included in the routine 1000, such that the routine 1000 may proceed from the step 1008 to the step 1012 without the operation flow record processing engine 202 first determining that the URL corresponding to the current web page matches the URL of the current step of the sharable record. For instance, in implementations in which (A) the operation flow record processing engine 202 always executes the steps of the sharable record sequentially, and (B) the user is forced to select a particular UI element on each web page while the sharable record is being executed (e.g., by causing all of the other UI elements on the page to become un-selectable), the fact that the web browser is rendering a particular web page at each step may be assumed.

At a step 1014 of the routine 1000, the operation flow record processing engine 202 may cause all of the UI elements on the current web page, except for a UI element corresponding to the element identifier identified for the current step of the sharable record, to be un-selectable. As discussed above in Section A, in some implementations, the operation flow record processing engine 202 may cause the UI elements of the web page to become un-selectable by adding an overlay layer to the DOM for the web page that is positioned on top of the UI elements. Alternatively, the operation flow record processing engine 202 may configure one or more particular attributes for the UI elements of the current web page to cause them to be un-selectable. As discussed above in Section A, when an overlay layer technique is employed, in some implementations, the operation flow record processing engine 202 may first add an overlay layer to the DOM for the web page (so that all of the UI elements on the web page are made un-selectable), and may then cause the UI element corresponding to the element identifier to be selectable by changing a positioning of the UI element within the DOM such that the UI element is positioned on top of the overlay layer. In other implementations, when the overlay layer is added to the DOM, the operation flow record processing engine 202 may determine a location of the UI element corresponding to the element identifier and position the overlay layer such that the overlay layer covers all of the UI elements on the current web page, but does not cover the UI element corresponding to the element identifier. Alternatively, the operation flow record processing engine 202 may configure one or more particular attributes for all of the UI elements on the web page, except for the UI element corresponding to the element identifier, to make them un-selectable.

At a decision 1016 of the routine 1000, the operation flow record processing engine 202 may determine whether the web browser has rendered a new web page. In some implementations, determining that the web browser has rendered a new web page may indicate to the operation flow record processing engine 202 that the second user 108b has selected the UI element corresponding to the element identifier for the current step of the sharable record, and that the operation flow record processing engine 202 is to move to the next step in the sharable record. When, at the decision 1016, the operation flow record processing engine 202 determines that the web browser has rendered a new page, the routine 1000 may proceed to a decision 1018, at which the operation flow record processing engine 202 may determine whether there are any steps remaining in the sharable record (e.g., rows remaining in the sharable record table 700).

When, at the decision 1018 of the routine 1000, the operation flow record processing engine 202 determines that there are no steps remaining in the sharable record (e.g., no rows remaining in the sharable record table 700), the routine 1000 may terminate. When, on the other hand, the operation flow record processing engine 202 determines that there are steps remaining in the sharable record (e.g., rows remaining in the sharable record table 700) the routine 1000 may return to the step 1008, at which the next step in the sharable record may be determined and the subsequent steps may again be executed as described above.

### G. Example Implementations of Methods, Systems, and Computer-Readable Media in Accordance With the Present Disclosure

The following paragraphs (M1) through (M19) describe examples of methods that may be implemented in accordance with the present disclosure.
(M1) A method may be performed that involves displaying, by a computing device, a first web page retrieved using a first uniform resource locator (URL), the first web page including at least a first user interface (UI) element; in response to a user providing a first input corresponding to the first UI element, storing first data representing the first URL and second data identifying the first UI element, the second data being stored in associated with the first data; in response to the user providing a second input corresponding to the first UI element, retrieving a second web page using a second URL associated with the first UI element, the second web page including at least a second UI element; and generating a sharable record including at least the first data and the second data, the sharable record being configured to be accessed by a browser to identify, based on the second data being associated with the first data, the first UI element on the first web page when the first web page is rendered by the browser.
(M2) A method may be performed as described in paragraph (M1), and may further involve, in response to the user providing a third input corresponding to the second UI element, storing third data representing the second URL and fourth data identifying the second UI element, the fourth data being stored in association with the third data, wherein the sharable record further includes the third data and the fourth data, and the sharable record is further configured to be accessed by the browser to identify, based on the fourth data being associated with the third data, the second UI element on the second web page when the second web page is rendered by the browser.
(M3) A method may be performed as described in paragraph (M1) or paragraph (M2), and may further involve, prior to the user providing the first input and in response to the user providing a third input corresponding to the first UI element, displaying at least one third UI element corresponding to an option to include an indicator of the first UI element in the sharable record, wherein the first input corresponds to selection of the at least one third UI element.
(M4) A method may be performed as described in any of paragraphs (M1) through (M3), wherein the first input and the second input may be a same action selecting the first UI element.
(M5) A method may be performed as described in any of paragraphs (M1) through (M4), wherein the first input and the second input may be different actions selecting the first UI element.
(M6) A method may be performed as described in any of paragraphs (M1) through (M5), and may further involve, in response to the user providing a third input corresponding to a third UI element of the first web page, storing third data representing the first URL and fourth data identifying the third UI element, the fourth data being stored in association with the third data, wherein the sharable record further includes the third data and the fourth data, and the sharable record is further configured to be accessed by the browser to identify, based on the fourth data being associated with the third data, the third UI element on the first web page after identifying the first UI element on the first web page.
(M7) A method may be performed as described in any of paragraphs (M1) through (M6), and may further involve receiving a third user input indicating the user has finished identifying UI elements for the sharable record; and in response to the receiving the third user input, generating the sharable record.
(M8) A method may be performed as described in any of paragraphs (M1) through (M7), and may further involve receiving user contact data corresponding to at least a second user; and sending, using the user contact data, a copy of the sharable record to the second user.
(M9) A method may be performed as described in any of paragraphs (M1) through (M8), and may further involve receiving a third user input indicating that subsequently selected UI elements are to be included in the sharable record, wherein the storing of the first data and the second data in response to the first input is based at least in part on receipt of the third user input.
(M10) A method may be performed as described in any of paragraphs (M1) through (M9), and may further involve including, in the sharable record, an indicator that a recipient browser is to process the sharable record using specialized code, the specialized code being configured to cause, based at least in part on the first data and the second data, at least one other element on the first web page to become un-selectable when the first web page is rendered by the recipient browser.
(M11) A method may be performed that involves displaying, by a computing device, at least a first user interface (UI) element corresponding to a sharable record, the sharable record including first data representing a first uniform resource locator (URL) corresponding to a first web page and second data identifying a second UI element on the first web page; in response to a user providing a first input selecting the first UI element, displaying, using the first URL, the first web page, the first web page including the second UI element and at least a third UI element; causing, based at least in part on the second data, the third UI element to be un-selectable; and in response to detecting a selection of the second UI element, taking at least one first action.
(M12) A method may be performed as described in paragraph (M11), wherein the sharable record may further include third data representing a second URL corresponding to a third web page and fourth data identifying a fourth UI element on the third web page, and wherein taking the at least one first action may further involve displaying the third web page, the third web page including the fourth UI element and at least a fifth UI element; causing, based at least in part on the fourth data, the fifth UI element to be un-selectable; and in response to detecting selection of the fourth UI element, taking at least one second action.
(M13) A method may be performed as described in paragraph (M12), wherein causing the second UI element to be un-selectable may further involve determining that the third web page has been rendered by a browser; determining that a third URL corresponding to the third web page matches the second URL included in the sharable record; and determining to cause the fifth UI element to be un-selectable based at least in part on the third URL of the third web page corresponding to the second URL included in the sharable record.
(M14) A method may be performed as described in any of paragraphs (M11) through (M13), wherein the sharable record may further include third data representing the first URL and fourth data identifying the third UI element on the first web page, and wherein taking the at least one first action may further involve causing the third UI element to be selectable; and causing the second UI element to be un-selectable.
(M15) A method may be performed as described in any of paragraphs (M11) through (M14), wherein the third UI element may be displayed on a first portion of the first web page, the second UI element may be displayed on a second portion of the first web page, and wherein causing the third UI element to be un-selectable may further involve positioning an overlay over at least the first portion of the first web page.
(M16) A method may be performed as described in any of paragraphs (M11) through (M15), and may further involve causing the computing system to position an overlay over at least the second UI element and third UI element on the first web page; and causing the second UI element to be selectable on the first web page by positioning the second UI element over the overlay.
(M17) A method may be performed as described in any of paragraphs (M11) through (M16), wherein causing the third UI element to be un-selectable may further involve configuring at least one attribute of the third UI element to cause the third UI element to be un-selectable.
(M18) A method may be performed as described in paragraph (M17), wherein configuring the at least one attribute may further involve disabling a selection functionality of the third UI element.
(M19) A method may be performed as described in any of paragraphs (M11) through (M18), and may further involve, in response to receiving the first input, retrieving, with a web browser, the first web page using the first URL included in the sharable record.

The following paragraphs (S1) through (S19) describe examples of systems and devices that may be implemented in accordance with the present disclosure.
(S1) A computing system may include at least one processor, and at least one computer-readable medium encoded with instructions which, when executed by the at least one processor, cause the computing system to display, by a computing device, a first web page retrieved using a first uniform resource locator (URL), the first web page including at least a first user interface (UI) element; in response to a user providing a first input corresponding to the first UI element, store first data representing the first URL and second data identifying the first UI element, the second data being stored in associated with the first data; in response to the user providing a second input corresponding to the first UI element, retrieve a second web page using a second URL associated with the first UI element, the second web page including at least a second UI element; and generate a sharable record including at least the first data and the second data, the sharable record being configured to be accessed by a browser to identify, based on the second data being associated with the first data, the first UI element on the first web page when the first web page is rendered by the browser.
(S2) A computing system may be configured as described in paragraph (S1), wherein the at least one computer-readable medium may be further encoded with additional instructions which, when executed by the at least one processor, further cause the computing system to, in response to the user providing a third input corresponding to the second UI element, store third data representing the second URL and fourth data identifying the second UI element, the fourth data being stored in association with the third data, wherein the sharable record may further include the third data and the fourth data, and the sharable record may further be configured to be accessed by the browser to identify, based on the fourth data being associated with the third data, the second UI element on the second web page when the second web page is rendered by the browser.
(S3) A computing system may be configured as described in paragraph (S1) or paragraph (S2), wherein the at least one computer-readable medium may be further encoded with additional instructions which, when executed by the at least one processor, further cause the computing system to, prior to the user providing the first input and in response to the user providing a third input corresponding to the first UI element, display at least one third UI element corresponding to an option to include an indicator of the first UI element in the sharable record, wherein the first input may correspond to selection of the at least one third UI element.
(S4) A computing system may be configured as described in any of paragraphs (S1) through (S3), wherein the first input and the second input may be a same action selecting the first UI element.
(S5) A computing system may be configured as described in any of paragraphs (S1) through (S4), wherein the first input and the second input may be different actions selecting the first UI element.
(S6) A computing system may be configured as described in any of paragraphs (S1) through (S5), wherein the at least one computer-readable medium may be further encoded with additional instructions which, when executed by the at least one processor, further cause the computing system to in response to the user providing a third input corresponding to a third UI element of the first web page, store third data representing the first URL and fourth data identifying the third UI element, the fourth data being stored in association with the third data, wherein the sharable record may further include the third data and the fourth data, and the sharable record may further be configured to be accessed by the browser to identify, based on the fourth data being associated with the third data, the third UI element on the first web page after identifying the first UI element on the first web page.
(S7) A computing system may be configured as described in any of paragraphs (S1) through (S6), wherein the at least one computer-readable medium may be further encoded with additional instructions which, when executed by the at least one processor, further cause the computing system to receive a third user input indicating the user has finished identifying UI elements for the sharable record; and in response to the receiving the third user input, generate the sharable record.
(S8) A computing system may be configured as described in any of paragraphs (S1) through (S7), wherein the at least one computer-readable medium may be further encoded with additional instructions which, when executed by the at least one processor, further cause the computing system to receive user contact data corresponding to at least a second user; and send, using the user contact data, a copy of the sharable record to the second user.
(S9) A computing system may be configured as described in any of paragraphs (S1) through (S8), wherein the at least one computer-readable medium may be further encoded with additional instructions which, when executed by the at least one processor, further cause the computing system to receive a third user input indicating that subsequently selected UI elements are to be included in the sharable record, wherein the storing of the first data and the second data in response to the first input is based at least in part on receipt of the third user input.
(S10) A computing system may be configured as described in any of paragraphs (S1) through (S9), wherein the at least one computer-readable medium may be further encoded with additional instructions which, when executed by the at least one processor, further cause the computing system to include, in the sharable record, an indicator that a recipient browser is to process the sharable record using specialized code, the specialized code being configured to cause, based at least in part on the first data and the second data, at least one other element on the first web page to become un-selectable when the first web page is rendered by the recipient browser.
(S11) A computing system may include at least one processor, and at least one computer-readable medium encoded with instructions which, when executed by the at least one processor, cause the computing system to display, by a computing device, at least a first user interface (UI) element corresponding to a sharable record, the sharable record including first data representing a first uniform resource locator (URL) corresponding to a first web page and second data identifying a second UI element on the first web page; in response to a user providing a first input selecting the first UI element, display, using the first URL, the first web page, the first web page including the second UI element and at least a third UI element; cause, based at least in part on the second data, the third UI element to be un-selectable; and in response to detecting a selection of the second UI element, take at least one first action.
(S12) A computing system may be configured as described in paragraph (S11), wherein the sharable record may further include third data representing a second URL corresponding to a third web page and fourth data identifying a fourth UI element on the third web page, and wherein the at least one computer-readable medium may be further encoded with additional instructions which, when executed by the at least one processor, further cause the computing system to take the at least one first action at least in part by displaying the third web page, the third web page including the fourth UI element and at least a fifth UI element; causing, based at least in part on the fourth data, the fifth UI element to be un-selectable; and in response to detecting selection of the fourth UI element, taking at least one second action.
(S13) A computing system may be configured as described in paragraph (S12), wherein the at least one computer-readable medium may be further encoded with additional instructions which, when executed by the at least one processor, further cause the computing system to cause the second UI element to be un-selectable at least in part by determining that the third web page has been rendered by a browser; determining that a third URL corresponding to the third web page matches the second URL included in the sharable record; and determining to cause the fifth UI element to be un-selectable based at least in part on the third URL of the third web page corresponding to the second URL included in the sharable record.
(S14) A computing system may be configured as described in any of paragraphs (S1) through (S13), wherein the sharable record may further include third data representing the first URL and fourth data identifying the third UI element on the first web page, and wherein the at least one computer-readable medium may be further encoded with additional instructions which, when executed by the least one processor, further cause the computing system to take the at least one first action at least in part by causing the third UI element to be selectable; and causing the second UI element to be un-selectable.
(S15) A computing system may be configured as described in any of paragraphs (S11) through (S14), wherein the third UI element may be displayed on a first portion of the first web page; the second UI element may be displayed on a second portion of the first web page; and the at least one computer-readable medium may be further encoded with additional instructions which, when executed by the at least one processor, further cause the computing system to cause the third UI element to be un-selectable at least in part by positioning an overlay over at least the first portion of the first web page.
(S16) A computing system may be configured as described in any of paragraphs (S11) through (S15), wherein the at least one computer-readable medium may be further encoded with additional instructions which, when executed by the at least one processor, further cause the computing system to position an overlay over at least the second UI element and third UI element on the first web page; and cause the second UI element to be selectable on the first web page by positioning the second UI element over the overlay.
(S17) A computing system may be configured as described in any of paragraphs (S11) through (S16), wherein the at least one computer-readable medium may be further encoded with additional instructions which, when executed by the at least one processor, further cause the computing system to cause the third UI element to be un-selectable at least in part by configuring at least one attribute of the third UI element to cause the third UI element to be un-selectable.
(S18) A computing system may be configured as described in paragraph (S17), wherein the at least one computer-readable medium may be further encoded with additional instructions which, when executed by the at least one processor, further cause the computing system to configure the at least one attribute at least in part by disabling a selection functionality of the third UI element.
(S19) A computing system may be configured as described in any of paragraphs (S11) through (S18), wherein the at least one computer-readable medium may be further encoded with additional instructions which, when executed by the at least one processor, further cause the computing system to, in response to receiving the first input, retrieve, with a web browser, the first web page using the first URL included in the sharable record.

The following paragraphs (CRM1) through (CRM19) describe examples of computer-readable media that may be implemented in accordance with the present disclosure.
(CRM1) At least one non-transitory computer-readable medium may be encoded with instructions which, when executed by the at least one processor, cause the computing system to display, by a computing device, a first web page retrieved using a first uniform resource locator (URL), the first web page including at least a first user interface (UI) element; in response to a user providing a first input corresponding to the first UI element, store first data representing the first URL and second data identifying the first UI element, the second data being stored in associated with the first data; in response to the user providing a second input corresponding to the first UI element, retrieve a second web page using a second URL associated with the first UI element, the second web page including at least a second UI element; and generate a sharable record including at least the first data and the second data, the sharable record being configured to be accessed by a browser to identify, based on the second data being associated with the first data, the first UI element on the first web page when the first web page is rendered by the browser.
(CRM2) At least one non-transitory computer-readable medium may be configured as described in paragraph (CRM1), and may be further encoded with additional instructions which, when executed by the at least one processor, further cause the computing system to in response to the user providing a third input corresponding to the second UI element, store third data representing the second URL and fourth data identifying the second UI element, the fourth data being stored in association with the third data, wherein the sharable record may further include the third data and the fourth data, and the sharable record may be further configured to be accessed by the browser to identify, based on the fourth data being associated with the third data, the second UI element on the second web page when the second web page is rendered by the browser.
(CRM3) At least one non-transitory computer-readable medium may be configured as described in paragraph (CRM1) or paragraph (CRM2), and may be further encoded with additional instructions which, when executed by the at least one processor, further cause the computing system to, prior to the user providing the first input and in response to the user providing a third input corresponding to the first UI element, display at least one third UI element corresponding to an option to include an indicator of the first UI element in the sharable record, wherein the first input may correspond to selection of the at least one third UI element.
(CRM4) At least one non-transitory computer-readable medium may be configured as described in any of paragraphs (CRM1) through (CRM3), wherein the first input and the second input may be a same action selecting the first UI element.
(CRM5) At least one non-transitory computer-readable medium may be configured as described in any of paragraphs (CRM1) through (CRM4), wherein the first input and the second input may be different actions selecting the first UI element.
(CRM6) At least one non-transitory computer-readable medium may be configured as described in any of paragraphs (CRM1) through (CRM5), and may be further encoded with additional instructions which, when executed by the at least one processor, further cause the computing system to, in response to the user providing a third input corresponding to a third UI element of the first web page, store third data representing the first URL and fourth data identifying the third UI element, the fourth data being stored in association with the third data, wherein the sharable record may further include the third data and the fourth data, and the sharable record may be further configured to be accessed by the browser to identify, based on the fourth data being associated with the third data, the third UI element on the first web page after identifying the first UI element on the first web page.
(CRM7) At least one non-transitory computer-readable medium may be configured as described in any of paragraphs (CRM1) through (CRM6), and may be further encoded with additional instructions which, when executed by the at least one processor, further cause the computing system to receive a third user input indicating the user has finished identifying UI elements for the sharable record; and in response to the receiving the third user input, generate the sharable record.
(CRM8) At least one non-transitory computer-readable medium may be configured as described in any of paragraphs (CRM1) through (CRM7), and may be further encoded with additional instructions which, when executed by the at least one processor, further cause the computing system to receive user contact data corresponding to at least a second user; and send, using the user contact data, a copy of the sharable record to the second user.
(CRM9) At least one non-transitory computer-readable medium may be configured as described in any of paragraphs (CRM1) through (CRM8), and may be further encoded with additional instructions which, when executed by the at least one processor, further cause the computing system to receive a third user input indicating that subsequently selected UI elements are to be included in the sharable record, wherein the storing of the first data and the second data in response to the first input may be based at least in part on receipt of the third user input.
(CRM10) At least one non-transitory computer-readable medium may be configured as described in any of paragraphs (CRM1) through (CRM9), and may be further encoded with additional instructions which, when executed by the at least one processor, further cause the computing system to include, in the sharable record, an indicator that a recipient browser is to process the sharable record using specialized code, the specialized code being configured to cause, based at least in part on the first data and the second data, at least one other element on the first web page to become un-selectable when the first web page is rendered by the recipient browser.
(CRM11) At least one non-transitory computer-readable medium may be encoded with instructions which, when executed by the at least one processor of a computing system, cause the computing system to display, by a computing device, at least a first user interface (UI) element corresponding to a sharable record, the sharable record including first data representing a first uniform resource locator (URL) corresponding to a first web page and second data identifying a second UI element on the first web page; in response to a user providing a first input selecting the first UI element, display using the first URL, the first web page, the first web page including the second UI element and at least a third UI element; cause, based at least in part on the second data, the third UI element to be un-selectable; and in response to detecting selection of the second UI element, take at least one first action.
(CRM12) At least one non-transitory computer-readable medium may be configured as described in paragraph (CRM11), wherein the sharable record may further include third data representing a second URL corresponding to a third web page and fourth data identifying a fourth UI element on the third web page, and wherein the least one non-transitory computer-readable medium may be further encoded with additional instructions which, when executed by the at least one processor, further cause the computing system to take the at least one first action at least in part by displaying the third web page, the third web page including the fourth UI element and at least a fifth UI element; causing, based at least in part on the fourth data, the fifth UI element to be un-selectable; and in response to detecting selection of the fourth UI element, taking at least one second action.
(CRM13) At least one non-transitory computer-readable medium may be configured as described in paragraph (CRM12), and may be further encoded with additional instructions which, when executed by the at least one processor, when executed by the at least one processor, further cause the computing system to cause the second UI element to be un-selectable at least in part by determining that the third web page has been rendered by a browser; determining that a third URL corresponding to the third web page matches the second URL included in the sharable record; and determining to cause the fifth UI element to be un-selectable based at least in part on the third URL of the third web page corresponding to the second URL included in the sharable record.
(CRM14) At least one non-transitory computer-readable medium may be configured as described in any of paragraphs (CRM11) through (CRM13), wherein the sharable record may further include third data representing the first URL and fourth data identifying the third UI element on the first web page, and wherein the at least one non-transitory computer-readable medium may be further encoded with additional instructions which, when executed by the least one processor, further cause the computing system to take the at least one first action at least in part by causing the third UI element to be selectable; and causing the second UI element to be un-selectable.
(CRM15) At least one non-transitory computer-readable medium may be configured as described in any of paragraphs (CRM11) through (CRM14), wherein the third UI element may be displayed on a first portion of the first web page; the second UI element may be displayed on a second portion of the first web page; and the at least one non-transitory computer-readable medium may be further encoded with additional instructions which, when executed by the at least one processor, further cause the computing system to cause the third UI element to be un-selectable at least in part by positioning an overlay over at least the first portion of the first web page.
(CRM16) At least one non-transitory computer-readable medium may be configured as described in any of paragraphs (CRM11) through (CRM15), and may be further encoded with additional instructions which, when executed by the at least one processor, when executed by the at least one processor, further cause the computing system to position an overlay over at least the second UI element and third UI element on the first web page; and cause the second UI element to be selectable on the first web page by positioning the second UI element over the overlay.
(CRM17) At least one non-transitory computer-readable medium may be configured as described in any of paragraphs (CRM11) through (CRM16), and may be further encoded with additional instructions which, when executed by the at least one processor, when executed by the at least one processor, further cause the computing system to cause the third UI element to be un-selectable at least in part by configuring at least one attribute of the third UI element to cause the third UI element to be un-selectable.
(CRM18) At least one non-transitory computer-readable medium may be configured as described in paragraph (CRM17), and may be further encoded with additional instructions which, when executed by the at least one processor, when executed by the at least one processor, further cause the computing system to configure the at least one attribute at least in part by disabling a selection functionality of the third UI element.
(CRM19) At least one non-transitory computer-readable medium may be configured as described in any of paragraphs (CRM11) through (CRM18), and may be further encoded with additional instructions which, when executed by the at least one processor, when executed by the at least one processor, further cause the computing system to, in response to receiving the first input, retrieve, with a web browser, the first web page using the first URL included in the sharable record.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

Various aspects of the present disclosure may be used alone, in combination, or in a variety of arrangements not specifically discussed in the embodiments described in the foregoing and is therefore not limited in this application to the details and arrangement of components set forth in the foregoing description or illustrated in the drawings. For example, aspects described in one embodiment may be combined in any manner with aspects described in other embodiments.

Also, the disclosed aspects may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence or order of one claim element over another or the temporal order in which acts of a method are performed, but are used merely as labels to distinguish one claimed element having a certain name from another element having a same name (but for use of the ordinal term) to distinguish the claim elements.

Also, the phraseology and terminology used herein is used for the purpose of description and should not be regarded as limiting. The use of “including,” “comprising,” or “having,” “containing,” “involving,” and variations thereof herein, is meant to encompass the items listed thereafter and equivalents thereof as well as additional items.

1. A method, comprising:
displaying, by a computing device, a first web page retrieved using a first uniform resource locator (URL), the first web page including at least a first user interface (UI) element;
in response to a user providing a first input corresponding to the first UI element, storing first data representing the first URL and second data identifying the first UI element, the second data being stored in association with the first data;
in response to the user providing a second input corresponding to the first UI element, retrieving a second web page using a second URL associated with the first UI element, the second web page including at least a second UI element; and
generating a sharable record including at least the first data and the second data, the sharable record being configured to be accessed by a browser to identify, based on the second data being associated with the first data, the first UI element on the first web page when the first web page is rendered by the browser.

2. The method of claim 1, further comprising:
in response to the user providing a third input corresponding to the second UI element, storing third data representing the second URL and fourth data identifying the second UI element, the fourth data being stored in association with the third data,
wherein:
the sharable record further includes the third data and the fourth data, and
the sharable record is further configured to be accessed by the browser to identify, based on the fourth data being associated with the third data, the second UI element on the second web page when the second web page is rendered by the browser.

3. The method of claim 1, further comprising:
prior to the user providing the first input and in response to the user providing a third input corresponding to the first UI element, displaying at least one third UI element corresponding to an option to include an indicator of the first UI element in the sharable record,
wherein the first input corresponds to selection of the at least one third UI element.

4. The method of claim 1, wherein the first input and the second input are a same action selecting the first UI element.

5. The method of claim 1, wherein the first input and the second input are different actions selecting the first UI element.

6. The method of claim 1, further comprising:
in response to the user providing a third input corresponding to a third UI element of the first web page, storing third data representing the first URL and fourth data identifying the third UI element, the fourth data being stored in association with the third data,
wherein:
the sharable record further includes the third data and the fourth data, and
the sharable record is further configured to be accessed by the browser to identify, based on the fourth data being associated with the third data, the third UI element on the first web page after identifying the first UI element on the first web page.

7. The method of claim 1, further comprising:
receiving a third user input indicating the user has finished identifying UI elements for the sharable record; and
in response to receiving the third user input, generating the sharable record.

8. The method of claim 1, further comprising:
receiving user contact data corresponding to at least a second user; and
sending, using the user contact data, a copy of the sharable record to the second user.

9. The method of claim 1, further comprising:
receiving a third user input indicating that subsequently selected UI elements are to be included in the sharable record,
wherein the storing of the first data and the second data in response to the first input is based at least in part on receipt of the third user input.

10. The method of claim 1, further comprising:
including, in the sharable record, an indicator that a recipient browser is to process the sharable record using specialized code, the specialized code being configured to cause, based at least in part on the first data and the second data, at least one other element on the first web page to become un-selectable when the first web page is rendered by the recipient browser.

11. A computing system comprising:
at least one processor; and
at least one computer-readable medium encoded with instructions which, when executed by the at least one processor, cause the computing system to:
display, by a computing device, at least a first user interface (UI) element corresponding to a sharable record, the sharable record including first data representing a first uniform resource locator (URL) corresponding to a first web page and second data identifying a second UI element on the first web page;
in response to a user providing a first input selecting the first UI element, display, using the first URL, the first web page, the first web page including the second UI element and at least a third UI element;
cause, based at least in part on the second data, the third UI element to be un-selectable; and
in response to detecting selection of the second UI element, take at least one first action.

12. The computing system of claim 11, wherein:
the sharable record further includes third data representing a second URL corresponding to a third web page and fourth data identifying a fourth UI element on the third web page, and
the at least one computer-readable medium is further encoded with additional instructions which, when executed by the at least one processor, further cause the computing system to take the at least one first action by:
displaying the third web page, the third web page including the fourth UI element and at least a fifth UI element;
causing, based at least in part on the fourth data, the fifth UI element to be un-selectable; and
in response to detecting selection of the fourth UI element, taking at least one second action.

13. The computing system of claim 12, wherein the at least one computer-readable medium is further encoded with additional instructions which, when executed by the at least one processor, further cause the computing system to cause the second UI element to be un-selectable by:
determining that the third web page has been rendered by a browser;
determining that a third URL corresponding to the third web page matches the second URL included in the sharable record; and
determining to cause the fifth UI element to be un-selectable based at least in part on the third URL of the third web page corresponding to the second URL included in the sharable record.

14. The computing system of claim 11, wherein:
the sharable record further includes third data representing the first URL and fourth data identifying the third UI element on the first web page, and
the at least one computer-readable medium is further encoded with additional instructions which, when executed by the at least one processor, further cause the computing system to take the at least one first action by:
causing the third UI element to be selectable; and
causing the second UI element to be un-selectable.

15. The computing system of claim 11, wherein:
the third UI element is displayed on a first portion of the first web page;
the second UI element is displayed on a second portion of the first web page; and
causing the third UI element to be un-selectable comprises positioning an overlay over at least the first portion of the first web page.

16. The computing system of claim 11, wherein the at least one computer-readable medium is further encoded with additional instructions which, when executed by the at least one processor, further cause the computing system to:
position an overlay over at least the second UI element and the third UI element on the first web page; and
cause the second UI element to be selectable on the first web page by positioning the second UI element over the overlay.

17. The computing system of claim 11, wherein the at least one computer-readable medium is further encoded with additional instructions which, when executed by the at least one processor, further cause the computing system to cause the third UI element to be un-selectable by:
configuring at least one attribute of the third UI element to cause the third UI element to be un-selectable.

18. The computing system of claim 17, wherein the at least one computer-readable medium is further encoded with additional instructions which, when executed by the at least one processor, further cause the computing system to configure the at least one attribute by:
disabling a selection functionality of the third UI element.

19. The computing system of claim 11, wherein the at least one computer-readable medium is further encoded with additional instructions which, when executed by the at least one processor, further cause the computing system to:
in response to receiving the first input, retrieve, with a web browser, the first web page using the first URL included in the sharable record.

20. At least one non-transitory computer-readable medium encoded with instructions which, when executed by at least one processor of a computing system, cause the computing system to:
display, by a computing device, at least a first user interface (UI) element corresponding to a sharable record, the sharable record including first data representing a first uniform resource locator (URL) corresponding to a first web page and second data identifying a second UI element on the first web page;
in response to a user providing a first input selecting the first UI element, display, using the first URL, the first web page, the first web page including the second UI element and at least a third UI element;
cause, based at least in part on the second data, the third UI element to be un-selectable; and
in response to detecting selection of the second UI element, take at least one first action.
